(19) United States
(12) Patent Application Publication
(10) Pub. No.: US 2021/0392482 A1
(43) Pub. Date: Dec. 16, 2021

(54) Triggering a Proximity-Based Digital Action with a Mobile Device and a Base Device

(71) Applicant: CRUNCHFISH DIGITAL CASH AB, Malmö (SE)

(72) Inventor: Kristian Sylwander, Bunkeflostrand (SE)

(21) Appl. No.: 17/295,661

(22) PCT Filed: Nov. 25, 2019
(86) PCT No.: PCT/SE2019/051193

§ 371 Date: May 20, 2021

(30) Foreign Application Priority Data
Nov. 26, 2018 (SE) 1851458-8
Mar. 19, 2019 (SE) 1950334-1

(51) Int. Cl. H04W 4/80; H04W 4/02

(52) U.S. Cl. CPC H04W 4/80; H04B 17/318; H04W 4/023

(57) ABSTRACT

A method of triggering a proximity-based digital action is presented. A base device is provided at a physical location. The base device has a wireless radio-frequency, RF, transceiver and a proximity sensor. A mobile device is also provided. The mobile device has a wireless RF transceiver. The method involves measuring received signal strength of RF communication between the base device and the mobile device, and obtaining a detection output of the proximity sensor of the base device. The method also involves evaluating a first proximity condition for the mobile device being proximate to the base device, the first proximity condition being based on the measured received signal strength. The method further involves evaluating a second proximity condition for the mobile device being proximate to the base device, the second proximity condition being based on a variation in detection output of the proximity sensor of the base device, the variation in the detection output being indicative of the mobile device appearing immediately close to the proximity sensor. The method finally involves triggering the proximity-based digital action when both of the first and second proximity conditions have been affirmed by the evaluations.

### TECHNICAL FIELD

The present invention generally relates to mobile communication, and more specifically to the use of a mobile device for triggering some kind of digital action depending on a proximity of the mobile device to a physical location. More specifically, the invention relates to a method of triggering a proximity-based digital action, the method involving a mobile device and a base device. The invention also relates to a mobile computing device for implementing the functionality of the mobile device in the method, and to a base device for implementing the functionality of the base device in the method. In addition, the invention relates to an associated communication system.

### BACKGROUND

Along with the overwhelming market penetration of mobile devices such as smartphones and tablets during the last decade, it has become generally desirable to be able to use mobile devices not only as means for telecommunication, but also as tools for facilitating the everyday life of their users. Nowadays, mobile devices are used as miniaturized personal computing devices and also for different services in electronic or physical commerce, consumption of digital content, gaming, social networking, etc.

In various situations, it may be desirable to perform an action when a person is close to a physical location.

For instance, in a retail premise (e.g. shop, supermarket or mall), it may be desired to allow the person to commit an affirmative, declining or cancelling action in a digital transaction that the person is participating in using his or her mobile device, or to provide the person with information involving the articles offered at a particular spot in the premises, for instance test reports, fact sheets, culinary recipes, nutritional information, discount coupons, etc.

In an office premise, it may for instance be desired for a person to perform a check-in action, or to control office equipment, or to cause placing of an order for goods which needs to be replenished in the office, or for a service which is required for some office equipment.

In a residential premise, it may for instance be desired for a person to control home equipment when being in proximity thereof, for instance to operate a wireless lock device or to cause placing of an order for goods which needs to be replenished in the household, or for a service which is required for some equipment in the home.

In an industrial premise, it may for instance be desired for a worker to control industrial equipment when being in proximity thereof, again for instance to operate a wireless lock device, or to order spare parts as needed. It may also be desired for an inspector, guard or manager to log checkpoints during a tour in the premise.

In an exhibition premise, it may for instance be desired for a visitor to retrieve information related to different exhibition objects when being near their respective spot of presentation.

In an outdoor scenery, it may for instance be desired for a tourist strolling around the scenery to get information or assistance when passing different attractions.

As a general inventive understanding behind this invention, the present inventor has realized that a mobile device may be used as a tool for causing some digital action to be performed depending on a proximity of the mobile device to a physical location in a more accurate way than in the prior art.

Reference is made to FIGS. 1A-1C, illustrating how a user U of a mobile device MD may be involved in proximity-based causing of activity. In FIG. 1A, the mobile device MD and user U are at a distance D0 from a physical location PL. Because of the magnitude of the distance D0 to the physical location PL, no activity is yet to be caused. As seen at 1 in FIG. 1B, the user U moves the mobile device MD closer to the physical location PL and is now at a shorter distance D1. However, the distance D1 is still too far, and no activity is yet to be caused.

Only once the user U has moved the mobile device MD much closer to the physical location PL, i.e. at a very short distance D2, activity shall be caused. This is seen at 2 in FIG. 1C.

An important factor is locational accuracy; it is often desired that the activity shall be performed only when the user U and the mobile device MD are quite close to the physical location PL. This means that activity 3 shall not be caused already in the situations shown in FIG. 1A and FIG. 1B, but only once the user U and the mobile device MD are really proximate to the physical location PL, i.e. the situation shown in FIG. 1C.

Verifying that the mobile device MD is really proximate to the physical location PL might be challenging. One common prior art approach involves using locational services provided by a mobile network operator and/or a satellite-based global positioning system to determine the location of the mobile device MD. However, this requires the mobile device MD to have a priori knowledge about the geographical coordinates of the physical location; the current location of the mobile device will have to be compared with the geographical coordinates of the physical location. It also requires availability of the locational services at the physical location PL. If this location is indoors or otherwise in a shielded environment, the location services may not be available, or the accuracy of them might be reduced.

Another prior art approach involves placing a radio transmitter at the physical location. This allows the mobile device to estimate the distance to the physical location by measuring and evaluating the received signal strength of radio communication from the radio transmitter. This approach is known to have shortcomings in positional accuracy; the received signal strength may vary not only as a function of the distance to the radio transmitter, but also because of challenges in the signal environment, such as scattering, interference and multi-path propagation.

Moreover, for the mobile device to make a distance estimation based on received signal strength, it needs a reference such as threshold or cross-reference values that translate received signal strength values to distances. Since mobile devices come in various different brands, models, sizes and types, and thus use a broad variety of radio transceiver circuitry, antennas, housing materials, etc, it is very difficult to provide a uniform set of threshold or cross-reference values which give the same, accurate distance estimates for different mobile devices.

Accordingly, there are problems and shortcomings with the prior art. The present inventor has identified improvements, as will be clear from the remainder of this document and the associated drawings.

### SUMMARY

It is accordingly an object of the invention to solve, eliminate, alleviate, mitigate or reduce at least some of the problems and shortcomings referred to above.

A first aspect of the present invention is a method of triggering a proximity-based digital action. The method comprises providing a base device at a physical location, the base device having a wireless radio-frequency, RF, transceiver and a proximity sensor. The method also comprises providing a mobile device having a wireless RF transceiver. The method further comprises measuring received signal strength of RF communication between the base device and the mobile device, and obtaining a detection output of the proximity sensor of the base device. The method moreover comprises evaluating a first proximity condition for the mobile device being proximate to the base device, the first proximity condition being based on the measured received signal strength. The method additionally comprises evaluating a second proximity condition for the mobile device being proximate to the base device, the second proximity condition being based on a variation in detection output of the proximity sensor of the base device, the variation in the detection output being indicative of the mobile device appearing immediately close to the proximity sensor. The method finally comprises triggering the proximity-based digital action when both of the first and second proximity conditions have been affirmed by the evaluations.

More specifically, the method according to the first aspect of the present invention may further comprise the base device producing proximity indicative data from detection output of the proximity sensor, the base device sending the proximity indicative data to the mobile device by RF communication, the mobile device receiving the proximity indicative data, and the mobile device evaluating the second proximity condition by determining whether the proximity indicative data satisfies predetermined criteria.

In different embodiments, the proximity sensor may, for instance and without limitation, be a light sensor for measuring incident light, a capacitive sensor, a Doppler effect sensor, an eddy current sensor, an inductive sensor, a magnetic sensor, an infrared sensor, an optical photoelectric sensor, a photocell sensor, a laser rangefinder sensor, a thermal sensor, a radar sensor, a sonar (acoustic) sensor, an ultrasonic sensor, a Hall effect sensor, a piezoelectric sensor, a mechanical switch sensor, or a mechanical displacement sensor. Hence, the term “proximity sensor” as used in this document shall be construed as a non-radio based sensor capable of detecting an object (e.g. the mobile device) appearing immediately close to the sensor by detecting a physical property being affected by the presence of such appearing object (e.g. mobile device) and accordingly providing a detection output, wherein the physical property is not a received radio (RF) signal strength.

The term “immediately close” shall thus be construed to mean the appearing object (e.g. mobile device) being close enough to the proximity sensor so as to cause a detectable variation or change in the physical property from an idle value or situation when the object (e.g. mobile device) was absent (i.e., not immediately close). In some embodiments, this may correspond to a distance of 0-10 cm between the appearing object (e.g. mobile device) and the proximity sensor, without limitation.

Features, advantages and embodiments of the first aspect of the invention are described in the following detailed description, claims and drawings.

A second aspect of the present invention is a mobile computing device comprising a controller and a short-range wireless communication interface. The mobile computing device is configured for measuring received signal strength of RF communication with a base device to establish a received signal strength value. The mobile computing device is also configured for evaluating, based on the measured received signal strength, a first proximity condition for the mobile device being proximate to the base device. The mobile computing device is further configured for receiving proximity indicative data from the base device, and for evaluating, based on the received proximity indicative data, a second proximity condition for the mobile device being proximate to the base device. The second proximity condition is based on a variation in detection output of a proximity sensor of the base device, the variation in the detection output being indicative of the mobile device appearing immediately close to the proximity sensor. The mobile computing device is finally configured for triggering a proximity-based digital action when both of the first and second proximity conditions have been affirmed.

The mobile computing device according to the second aspect of the invention may implement the mobile device referred to in the method according to the first aspect of the invention. Accordingly, the mobile computing device according to the second aspect of the invention may be configured for performing the functionality defined for the mobile device in the method according to the first aspect of the invention and as described throughout this document.

A third aspect of the present invention is a base device comprising a controller, a short-range wireless communication interface and a proximity sensor. The base device is configured for communicating with a mobile device by RF communication, producing proximity indicative data from detection output of the proximity sensor, and sending the proximity indicative data to the mobile device by RF communication.

More specifically, the base device according to the third aspect of the present invention may be configured for producing the proximity indicative data from the detection output of the proximity sensor such that the proximity indicative data will enable the mobile device to evaluate whether the mobile device is being proximate to the base device based on a variation in the detection output of the proximity sensor, the variation in the detection output thus being indicative of the mobile device appearing immediately close to the proximity sensor.

The base device according to the third aspect of the invention may implement the base device referred to in the method according to the first aspect of the invention. Accordingly, the base device according to the third aspect of the invention may be configured for performing the functionality defined for the base device in the method according to the first aspect of the invention and as described throughout this document.

A fourth aspect of the present invention is a communication system comprising one or more mobile computing devices according to the second aspect of the invention and a base device according to the third aspect of the invention.

Other aspects, objectives, features and advantages of the disclosed embodiments will appear from the following detailed disclosure, from the attached dependent claims as well as from the drawings. Generally, all terms used in the claims are to be interpreted according to their ordinary meaning in the technical field, unless explicitly defined otherwise herein.

All references to “a/an/the [element, device, component, means, step, etc]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF DRAWINGS

FIGS. 1A-1C illustrate how a user of a mobile device may be involved in proximity-based causing of digital activity.

FIG. 2A illustrates a communication system generally according to the present invention, involving a mobile device and a base device provided at a physical location, the mobile device approaching the base device and receiving an RF announcement signal from the base device.

FIG. 2B illustrates the communication system of FIG. 2A, showing the mobile device moving closer to the base device and commencing RF communication with the base device.

FIG. 2C illustrates the communication system of FIGS. 2A and 2B, showing the mobile device moving even closer to the base device, the mobile device's proximity to the base device being affirmed by a combination of received signal strength evaluation and use of a proximity sensor at the base device, and a digital action being triggered upon successful affirmation of proximity.

FIG. 3 is a flowchart diagram of a general method of triggering a proximity-based digital action according to the present invention.

FIGS. 4A-4B illustrate embodiments of the invention.

FIGS. 5A-5E illustrate further embodiments of the invention.

FIG. 6A illustrates a mobile computing device which may implement the mobile device as described in this document.

FIG. 6B illustrates a base device which may implement the base device as described in this document.

FIGS. 6C-6F illustrate different exemplifying embodiments of the base device in FIG. 6B.

FIG. 7 is a flowchart diagram of a general method of triggering a proximity-based digital action in an embodiment where the proximity sensor is a light sensor for measuring incident light.

FIGS. 8A-8B illustrate refinements of the embodiment of FIG. 7.

FIGS. 9A-9E illustrate further refinements of the embodiment of FIG. 7.

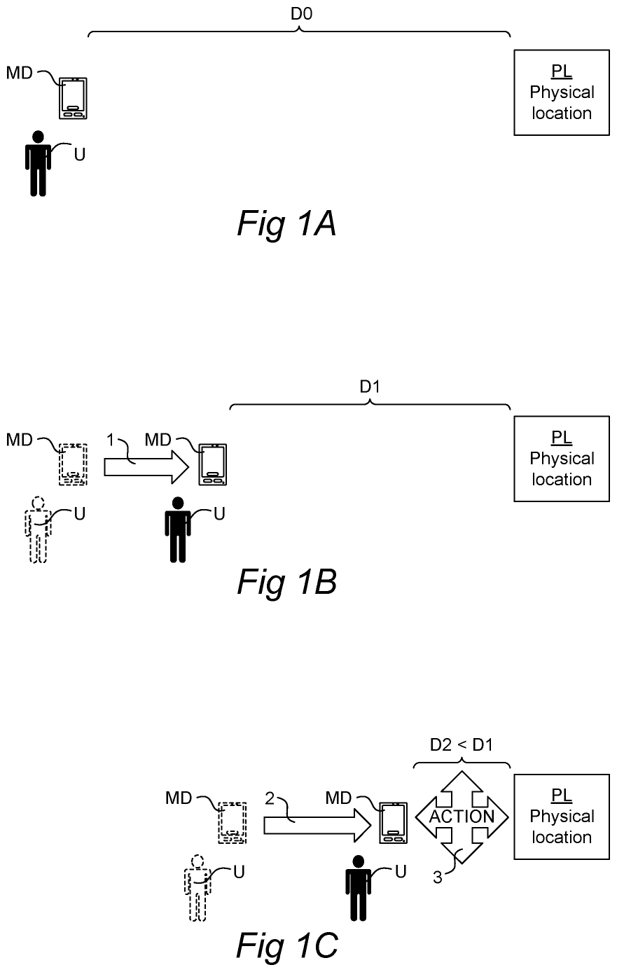

### DETAILED DESCRIPTION

The disclosed embodiments will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout.

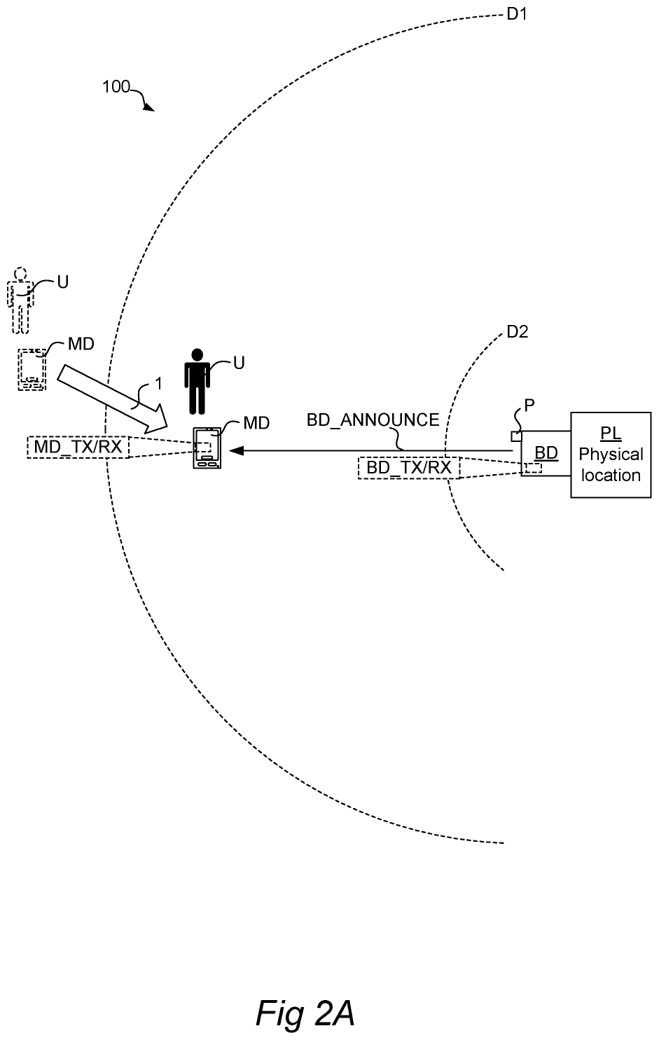

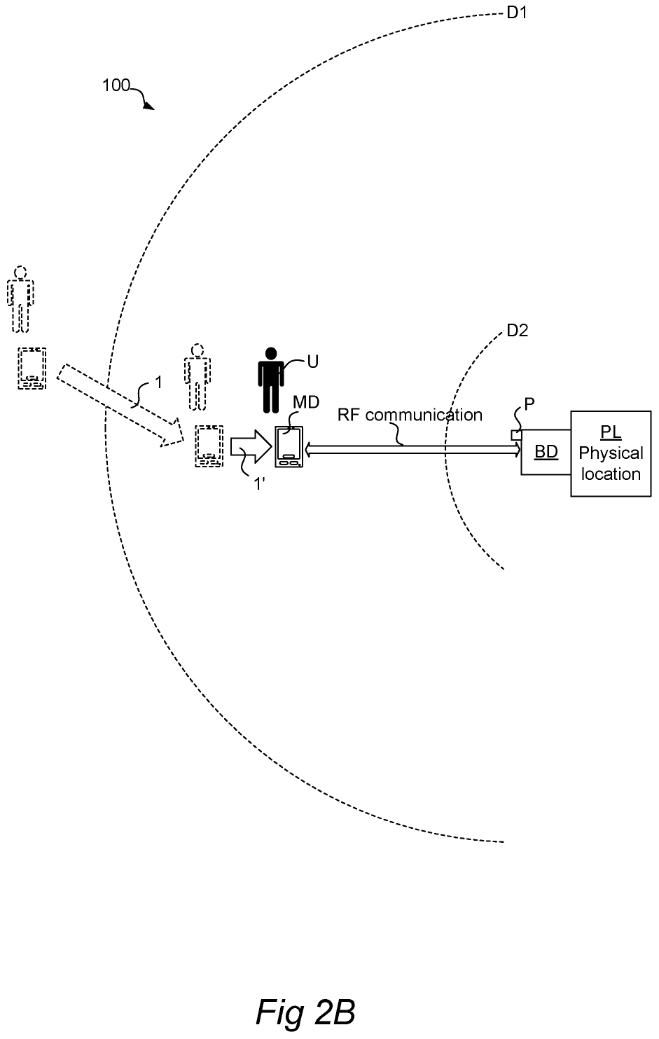

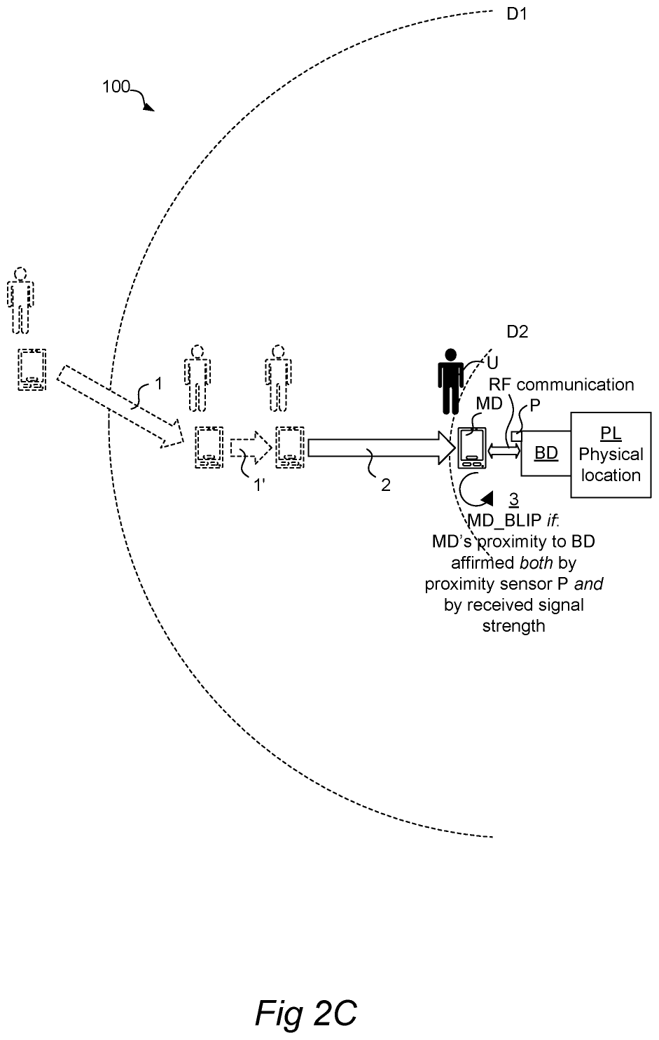

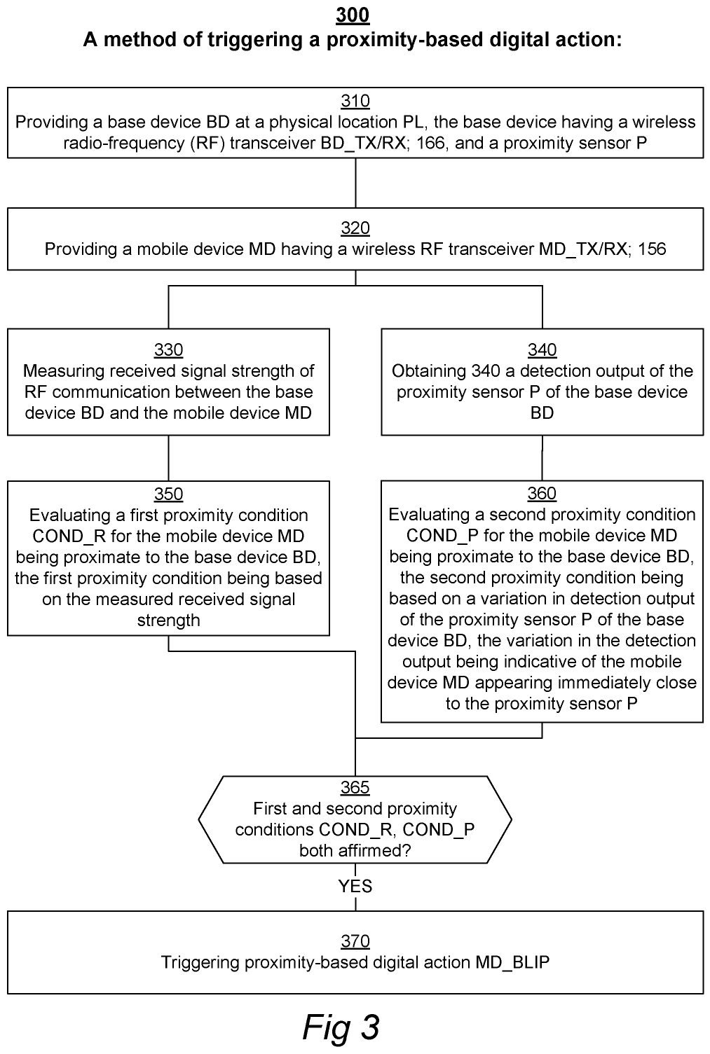

Reference is first made to FIG. 2A, FIG. 2B and FIG. 2C which illustrate a communication system 100 generally according to the present invention. A method of triggering a proximity-based digital action by a mobile device MD when a user U brings the mobile device MD close to a physical location PL may be performed in the communication system 100. This method is illustrated as a flowchart diagram in FIG. 3 and will be described in more detail later.

The physical location PL may, for instance and without limitation, be a retail premise (like a shop, supermarket or mall), an office premise, a residential premise (like a private home or a hotel), an industrial premise (like a factory or plant), an exhibition premise (like a fair, gallery or museum), or an outdoor scenery.

The communication system 100 comprises the mobile device MD as well as a base device BD. The mobile device MD has a wireless radio-frequency, RF, transceiver MD_TX/RX. The base device BD is provided at the physical location PL and has a wireless RF transceiver BD_TX/RX and a proximity sensor P. In the disclosed embodiment, however without limitation, the wireless RF transceivers MD_TX/RX and BD_TX/RX are compliant with Bluetooth Low Energy, BLE.

The base device BD is configured for sending a short-range wireless announcement signal BD_ANNOUNCE by the wireless RF transceiver BD_TX/RX. (Other embodiments may operate without a short-range wireless announcement signal.)

When the mobile device MD is too far from the base device BD, e.g. at a distance exceeding D1 in FIG. 2A, it is out of range and will not receive the announcement signal BD_ANNOUNCE. When it moves closer, see 1 in FIG. 2A, i.e. to a distance shorter than D1, it may receive the announcement signal BD_ANNOUNCE and, in some embodiments, begin RF communication with the base device BD while approaching closer to the base device BD as seen at 1′. This can be seen in FIG. 2B.

In FIG. 2C, the mobile device MD moves still closer to the base device MD, as seen at 2. The mobile device MD is now in such close proximity to the base device (and, thus, the physical location PL) that it is desired to trigger a digital action. Pursuant to the general inventive idea, the close proximity of the mobile device MD to the base device BD is affirmed by a combination of two things: a received signal strength evaluation and an evaluation of detection output of the proximity sensor P at the base device BD. The purpose of the proximity sensor P is to detect a variation in a physical property monitored, measured or otherwise sensed by the proximity sensor P when the mobile device is so close to the proximity sensor P (and therefore to the base device BD and the physical location PL), that the presence of the mobile device MD will cause a detectable variation or change in the physical property, as compared to an idle value or situation when the mobile device was absent (i.e., not immediately close to the proximity sensor P).

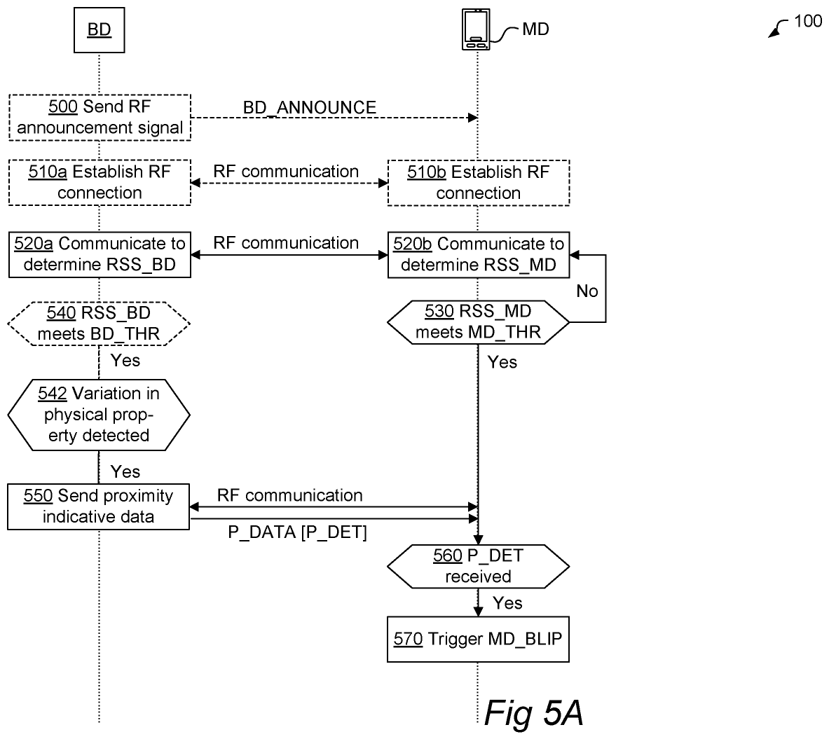

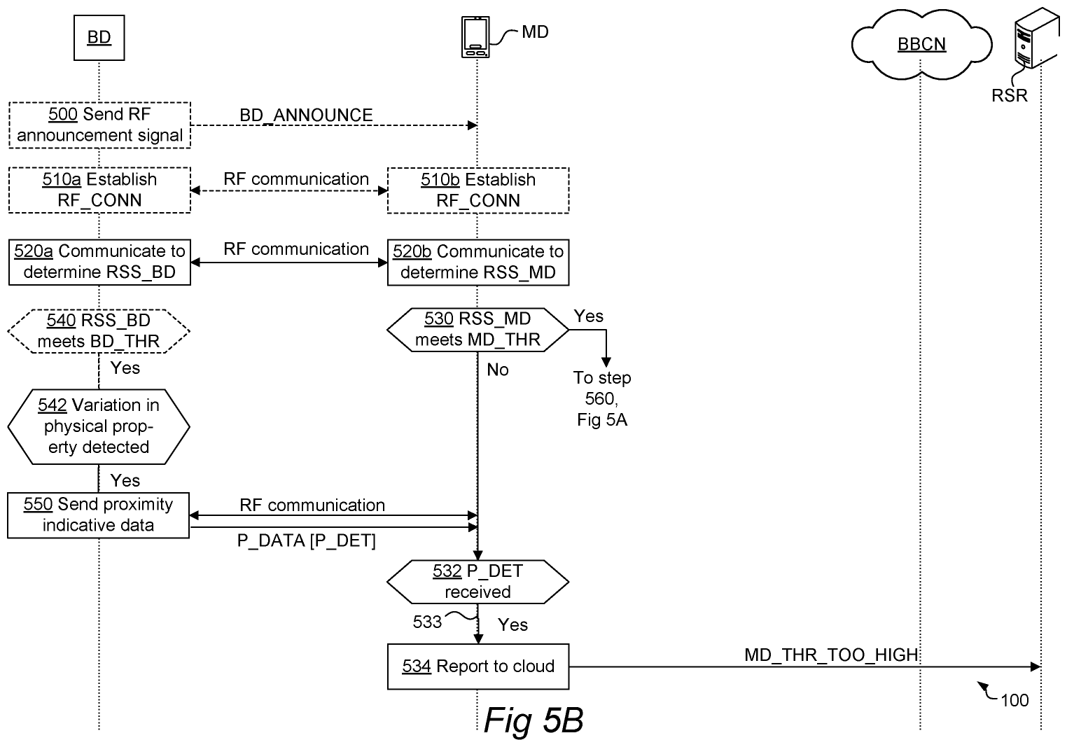

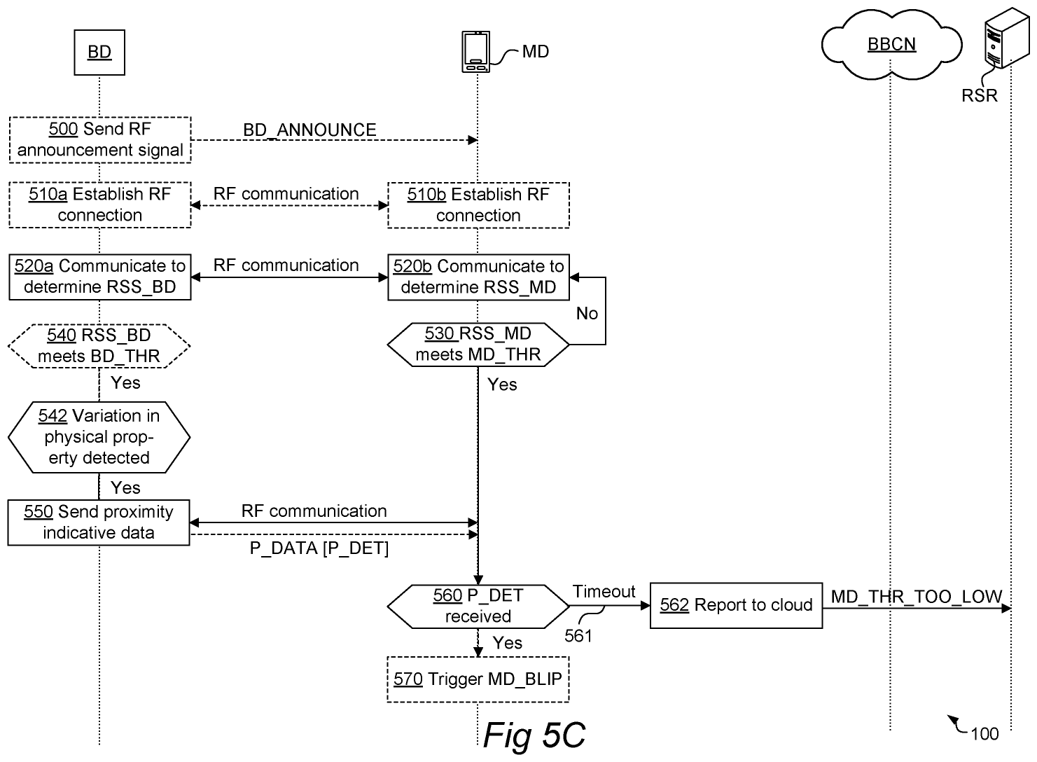

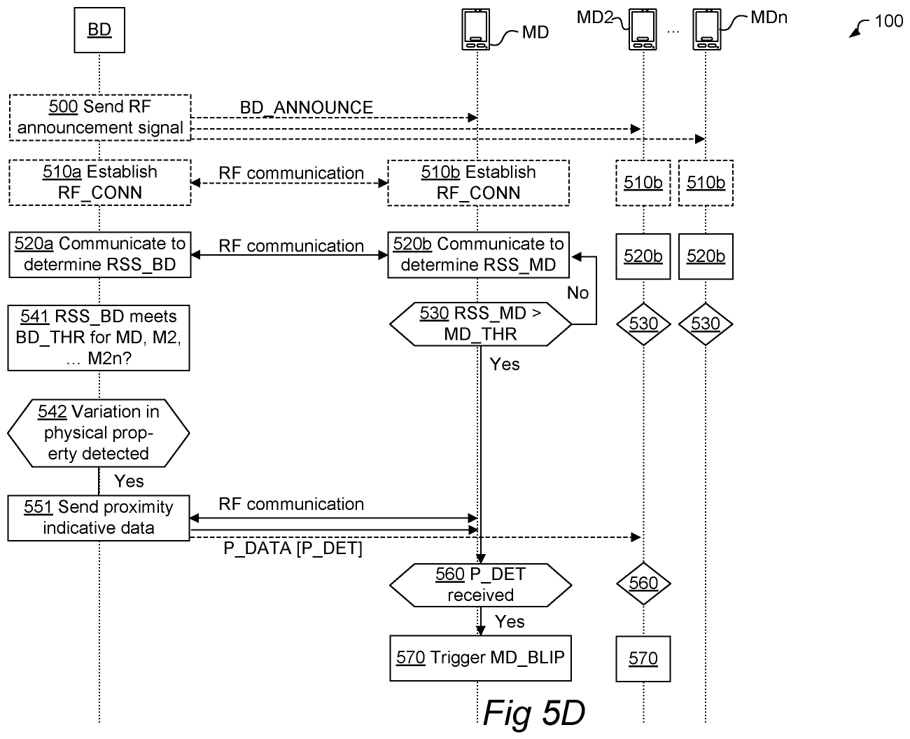

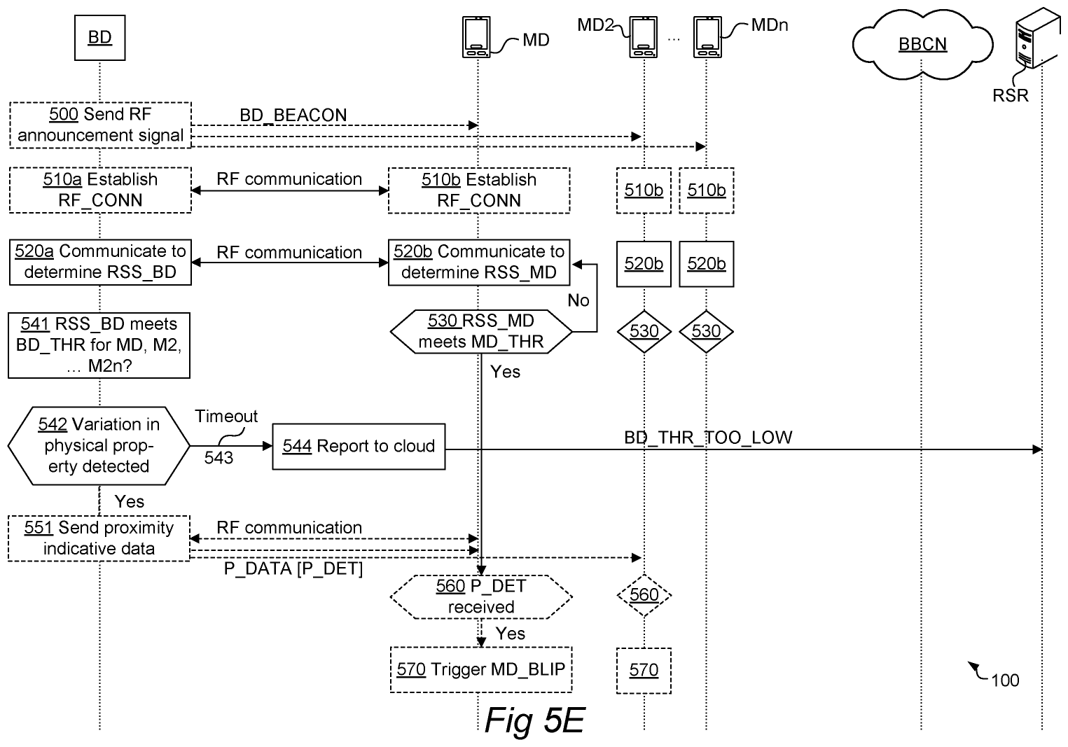

A digital action MD_BLIP will be triggered only upon successful affirmation of both the received signal strength evaluation and the evaluation of detection output from the proximity sensor P. The digital action MD_BLIP is seen at 3 in FIG. 2C and may typically involve invoking a command, function or message in a software application in the mobile device MD and/or in a remote server resource in communication with the mobile device MD over a mobile broadband data network or similar. See, for instance, broadband communication network BBCN and remote server resource RSR in FIGS. 5B, 5C and 5E.

In FIGS. 2A-2C, the distances D1 and D2 are, of course, purely for exemplifying purposes and shall not be given any weight to scale. The first distance D1 may, for instance, be 1-50 m, or more preferably 2-10 m, without limitation and depending on the targets and specifications of an actual implementation. The second distance may be 0-25 cm, or more preferably 0-10 cm, without limitation and, again, depending on the targets and specifications of an actual implementation.

Continuing from the brief introduction to the inventive functionality given above, reference is now made to FIG. 3. FIG. 3 is a flowchart diagram of a general method 300 of triggering a proximity-based digital action according to the present invention.

The method 300 involves the following.

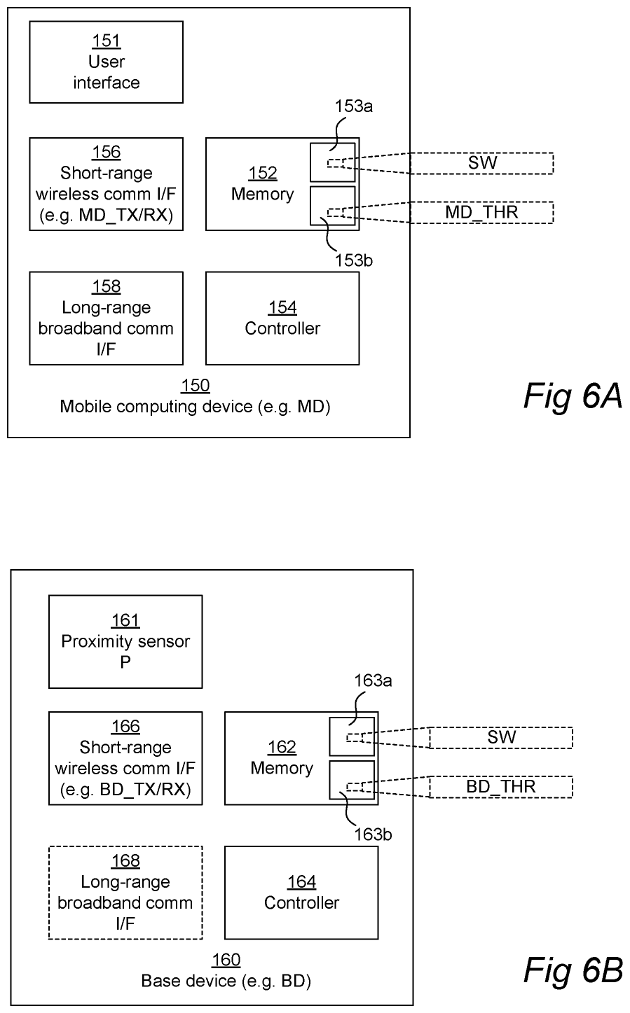

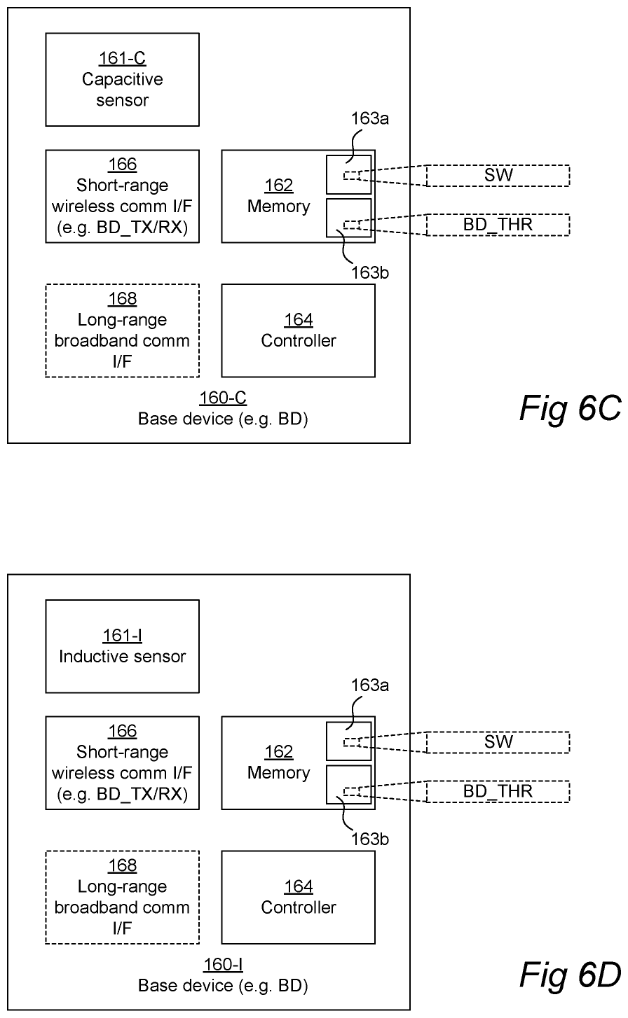

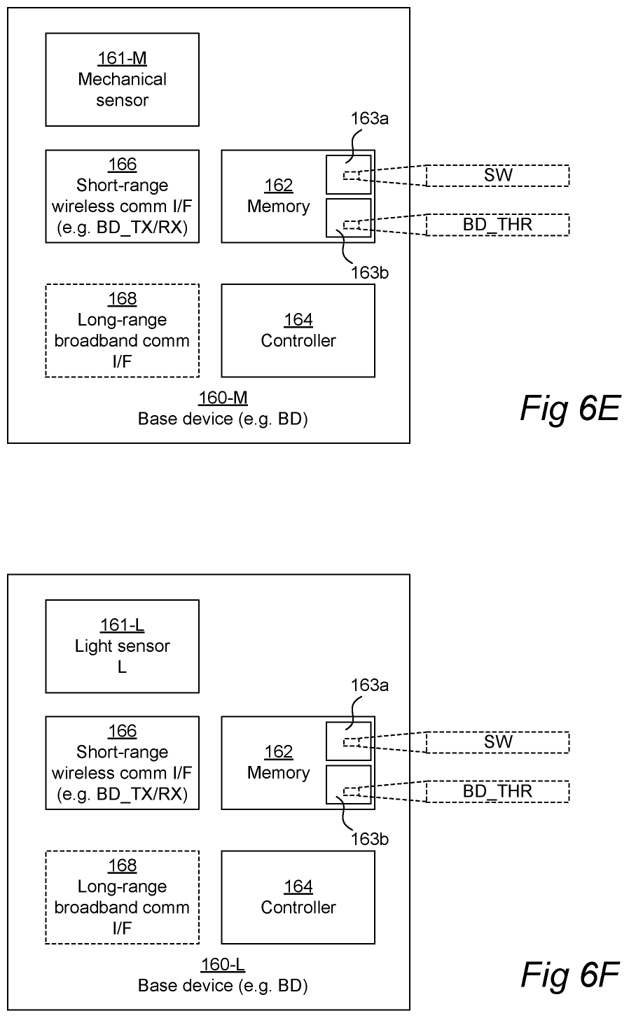

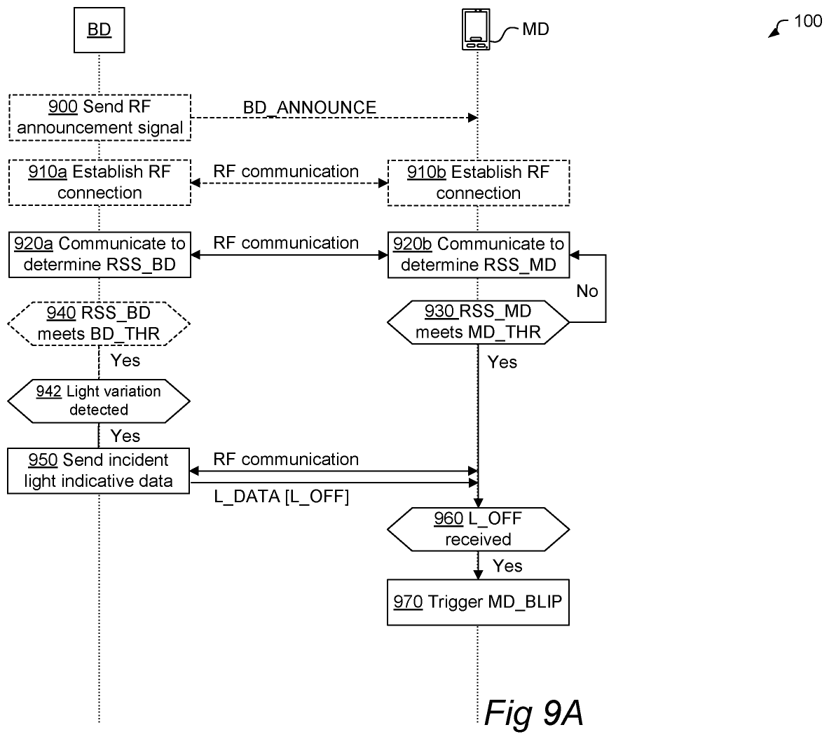

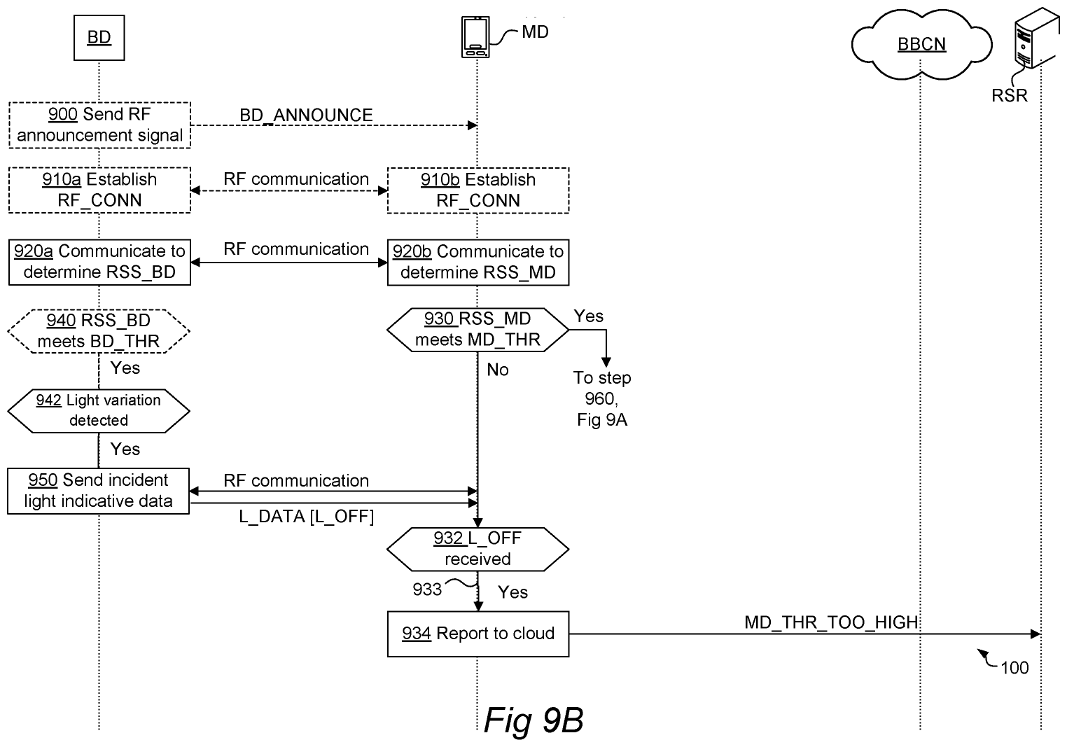

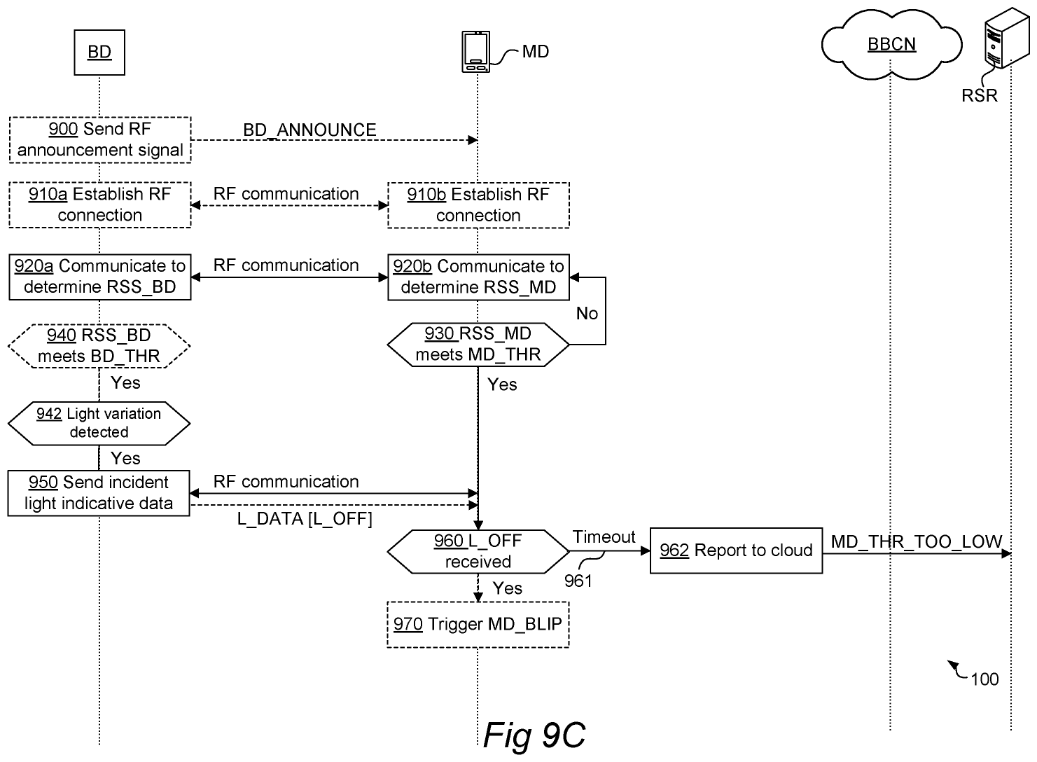

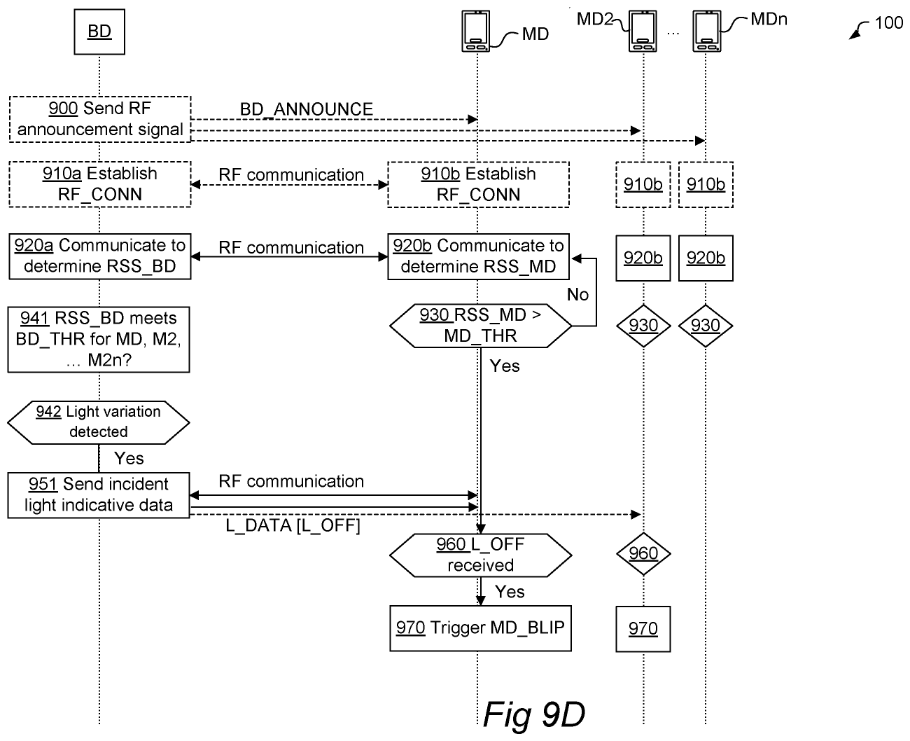

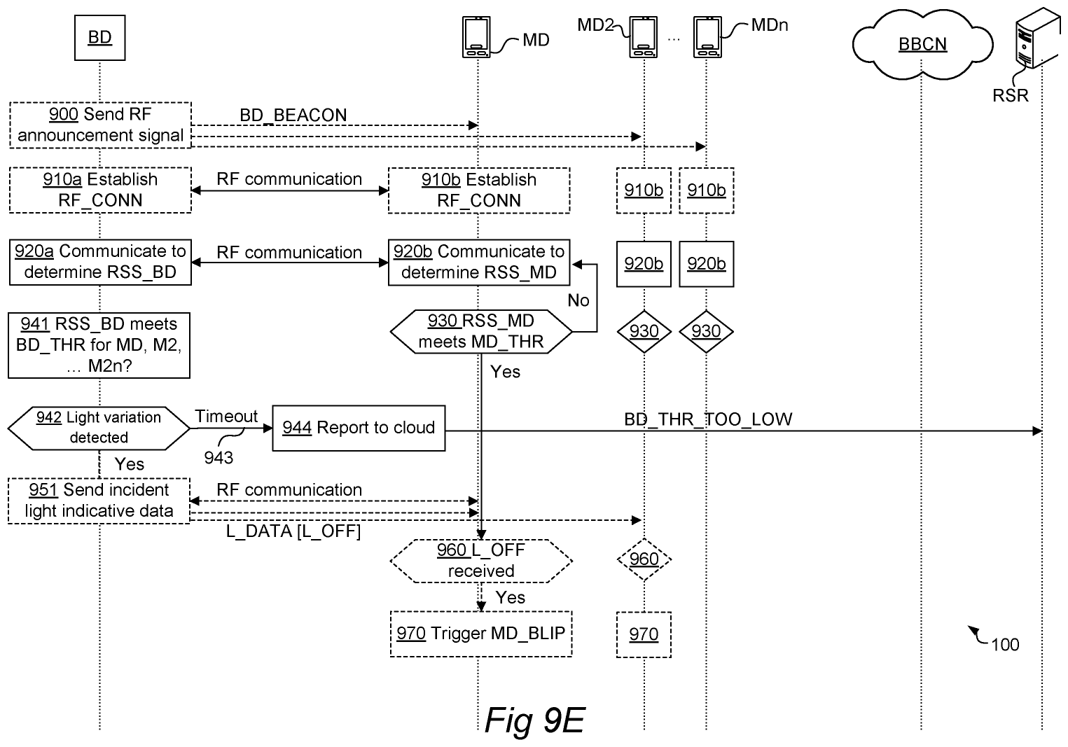

As already mentioned and seen at 310 in FIG. 3, the base device BD is provided at a physical location PL. It is recalled that the base device BD has a wireless RF transceiver BD_TX/RX and a proximity sensor P. The proximity sensor P may, for instance, be a light sensor for measuring incident light, a capacitive sensor, a Doppler effect sensor, an eddy current sensor, an inductive sensor, a magnetic sensor, an infrared sensor, an optical photoelectric sensor, a photocell sensor, a laser rangefinder sensor, a thermal sensor, a radar sensor, a sonar (acoustic) sensor, an ultrasonic sensor, a Hall effect sensor, a piezoelectric sensor, a mechanical switch sensor, or a mechanical displacement sensor. Some exemplifying embodiments will be described later in this document, where the proximity sensor P is a light sensor L for measuring incident light (FIGS. 6, 7A-7B, 8A-8E and FIG. 9F), a capacitive sensor (FIG. 9C), an inductive sensor (FIG. 9D) and a mechanical switch or displacement sensor (FIG. 9E), respectively. Generally, however, any proximity sensor may be used that is capable of detecting a variation in a physical property monitored, measured or otherwise sensed by the proximity sensor P when the mobile device MD is so close to the proximity sensor P (and therefore to the base device BD and the physical location PL), that the presence of the mobile device MD will cause a detectable variation or change in the physical property, as compared to an idle value or situation when the mobile device was absent (i.e., not immediately close to the proximity sensor P).

As seen at 320 in FIG. 3, the method 300 also involves providing the mobile device MD. It is recalled that the mobile device has a wireless RF transceiver MD_TX/RX.

The method 300 further involves measuring, see 330, received signal strength of RF communication between the base device BD and the mobile device MD, as well as obtaining, see 340, a detection output of the proximity sensor P of the base device BD.

The method 300 then involves evaluating, see 350, a first proximity condition COND_R for the mobile device MD being proximate to the base device BD. As will be described in more detail with reference to the remaining drawings, the first proximity condition is based on the measured received signal strength.

The method 300 also involves evaluating, see 360, a second proximity condition COND_P for the mobile device MD being proximate to the base device BD. The second proximity condition is based on a variation in detection output of the proximity sensor P of the base device BD. Hence, the variation in the detection output is indicative of the mobile device MD appearing immediately close to the proximity sensor P, as a result of the user U bringing the mobile device MD within, for instance, a 0-10 cm distance from the proximity sensor P.

The proximity-based digital action MD_BLIP is triggered, see 370, only when both of the first and second proximity conditions COND_R, COND_P have been affirmed, see 365, by the evaluations 350 and 360.

The sequence of steps 330 and 350 on the one hand, and the sequence of steps 340 and 360 on the other hand, may be performed in parallel or in any mutually sequential order.

The method in FIG. 3 has considerable advantages. It represents a substantial improvement in accuracy over distance estimation based purely on received radio (RF) signal strength, as described in the background section of this document. The provision and inventive use of the proximity sensor P (i.e. the second proximity condition COND_P) allow for an additional verification of the mobile device's MD close proximity to the base device BD, thereby considerably improving the positional accuracy of the method of triggering a proximity-based digital action. The proximity sensor P will only detect a variation in the physical property monitored, measured or otherwise sensed by the proximity sensor P when the mobile device MD (or another object) is immediately close to the proximity sensor P and base device BD. Moreover, the parallel use of the distance estimation based on received signal strength (i.e. the first proximity condition COND_R) will minimize the risk of inadvertent triggering of the digital action MD_BLIP caused by the proximity sensor P detecting an object not being the mobile device MD or the user U.

The method in FIG. 3 is advantageous also over other conceivable types of combined verification of the mobile device's MD close proximity to the base device BD. For instance, an alternative solution (not to be confused with the present invention), where the mobile device rather than the base device would be provided with a non-RF-based mechanism for combined proximity verification, would be clearly inferior to the claimed invention. If, for instance, the mobile device were to be equipped with a magnetic, light-based, sound-based or vibration-based proximity sensor for measuring a distance to the base device, then such a solution would be disadvantageous for quite the same reasons as referred to above in the background section of this document. Mobile devices come in various different brands, models, sizes and types. It would thus be very difficult to establish a universal standard for the location of such a magnetic, light-based, sound-based or vibration-based proximity sensor on or within the apparatus housing of the mobile device, bearing in mind the broadly varying housing sizes, shape and materials of such apparatus housings. The base device of the present invention, on the other hand, need not be a globally distributed consumer product made by various different manufactures and can thus be designed in one single standard way (or a controlled limited number of ways), applicable to all instances of the base device.

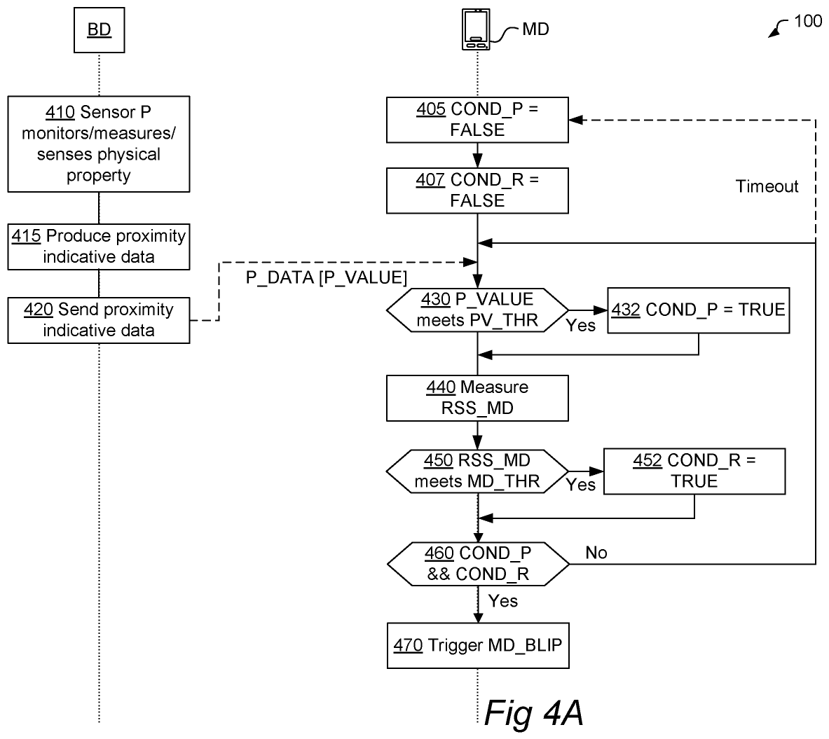

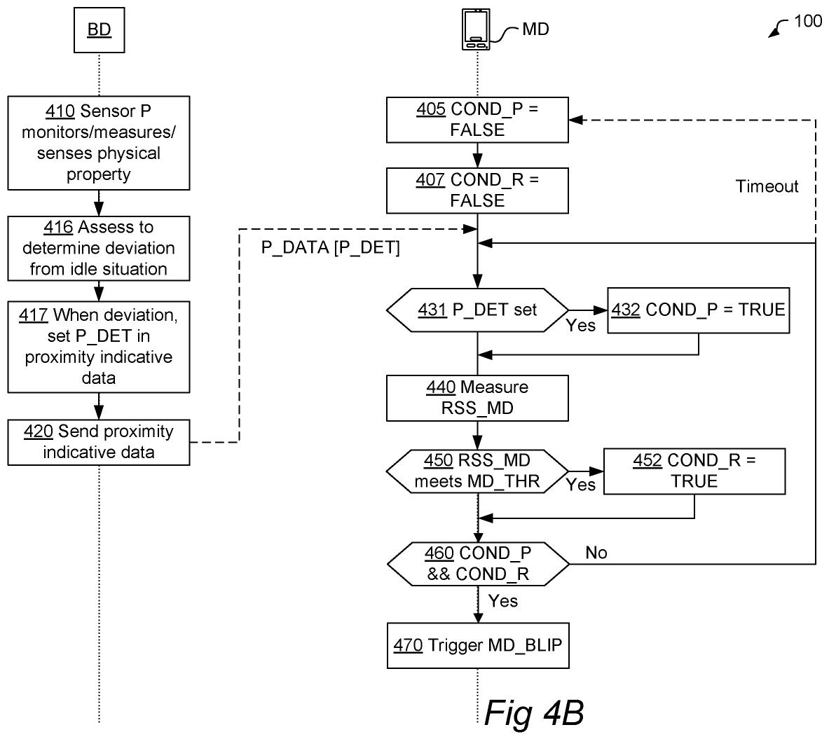

Embodiments of the method 300 and communication system 100 are shown in FIG. 4A and FIG. 4B. As seen at 410, the proximity sensor P of the base device BD monitors, measures or otherwise senses a physical property which may be affected by the presence or absence of the mobile device MD (or other object) being immediately close to the proximity sensor P, as previously described. The base device BD is configured for producing 415 (FIG. 4A); 416-417 (FIG. 4B) proximity indicative data P_DATA from the detection output of the proximity sensor P. The base device BD is configured for sending 420 the proximity indicative data P_DATA to the mobile device MD by RF communication. The proximity indicative data P_DATA may be broadcasted in an RF signal to be received by all devices within range, for instance in a Scan Response message. Alternatively, if an RF connection, such as a BLE link, has been established between the mobile device MD and the base device (cf 510a and 510b in FIG. 5A-FIG. 5E), the proximity indicative data P_DATA may be addressed individually to the mobile device MD.

The mobile device MD is configured for receiving the proximity indicative data P_DATA from the base device BD. The mobile device MD is further configured for evaluating the second proximity condition COND_P by determining 430 (FIG. 4A); 431 (FIG. 4B) whether the received proximity indicative data P_DATA satisfies predetermined criteria.

The mobile device MD is further configured for evaluating the first proximity condition COND_R by measuring 440 received signal strength of RF communication with the base device BD to establish a received signal strength value RSS_MD. The mobile device MD compares 450 the received signal strength value RSS_MD to a threshold value MD_THR, and affirms 452 the first proximity condition COND_R when the received signal strength value RSS_MD meets the threshold value MD_THR.

The received signal strength may, for instance, be determined from an RSSI (Received Signal Strength Indicator) included in RF communication from the base device BD. The RSSI may be expressed in dBm and have typical negative values ranging between 0 dBm (excellent signal) and, for instance, −110 dBm (extremely poor signal). Generally, the shorter distance between the base device BD and the mobile device MD, the higher RSSI.

The RF communication from the base device BD may, for instance, be the short-range wireless announcement signal BD_ANNOUNCE which was described for FIG. 2A, or RF communication resulting from the establishment of an RF connection between the base device BD and mobile device MD (cf FIG. 5A-FIG. 5E).

As seen at 460 and 470 in FIG. 4A and FIG. 4B, the mobile device MD is configured for checking whether both of the first and second proximity conditions COND_R, COND_P have been affirmed, as indicated by their logically true values set in steps 432 and 452 (initially, in steps 405 and 407, logically false values have been set for the first and second proximity conditions COND_R, COND_P).

The mobile device MD is further configured, when the outcome of the check in 460 is affirmative for both COND_R and COND_P, to trigger the digital action MD_BLIP in 470.

In the embodiment of FIG. 4A, the proximity indicative data P_DATA produced 415 by the base device BD comprises a value P_VALUE which is representative of the detection output of the proximity sensor P. More specifically, the representative value P_VALUE may be an absolute value of the physical property monitored, measured or otherwise sensed by proximity sensor P. In some embodiments, the representative value P_VALUE may be an average of a sequence of readings of the detection output of the proximity sensor P.

Alternatively, the representative value P_VALUE may be a relative value of the physical property monitored, measured or otherwise sensed by proximity sensor P. The relative value may be defined in relation to a reference value which represents an idle situation where the proximity sensor P is not interfered with by the mobile device MD or any other object being immediately close to the proximity sensor P. Again, the representative value P_VALUE is derived from the detection output of the proximity sensor P, advantageously from an average of a sequence of readings of the detection output of the proximity sensor P.

The mobile device MD is configured to evaluate the second proximity condition COND_P by comparing 430 the representative value P_VALUE to a threshold value PV_THR, being an absolute threshold value or a relative threshold value as the case may be.

In a refined version of the embodiment of FIG. 4A, the base device BD is configured for repeatedly producing 415 the proximity indicative data P_DATA and its representative value P_VALUE, and for repeatedly sending 420 the proximity indicative data P_DATA including the representative value P_VALUE to the mobile device MD. This may improve stability and reliability. The mobile device MD is configured for repeatedly receiving and evaluating 430 the proximity indicative data P_DATA. The second proximity condition COND_P is affirmed 432 when the representative value P_VALUE in the received proximity indicative data P_DATA meets the threshold value PV_THR for a certain period of time.

In the embodiment of FIG. 4B, the base device BD is configured for producing the proximity indicative data P_DATA by assessing 416 one or more readings of the detection output of the proximity sensor P to determine a deviation from an idle situation in which the proximity sensor P is not interfered with by the mobile device MD or any other object being immediately close to the proximity sensor P. When the deviation from the idle situation has been determined, the base device BD is configured for providing 417 a proximity detection indicator P_DET in or as the proximity indicative data P_DATA which is then sent 420 to the mobile device MD. The proximity detection indicator P_DET may be included as a data field in the proximity indicative data P_DATA, or it may constitute the entire proximity indicative data P_DATA, depending on implementation.

The mobile device MD is configured for evaluating the second proximity condition COND_P by detecting 431 the proximity detection indicator P_DET in the received proximity indicative data P_DATA. The second proximity condition COND_P is affirmed 432 when the proximity detection indicator P_DET is detected.

In a refined version of the embodiment of FIG. 4B, for improved stability and reliability, the base device BD is configured for repeatedly assessing 416 the detection output from the proximity sensor P and providing 417 the proximity detection indicator P_DET when the deviation from the idle situation has prevailed for a certain period of time.

Further embodiments are shown in FIG. 5A-5E. In FIG. 5A, the base device BD may send 500 an RF announcement signal BD_ANNOUNCE which may be received by the mobile device MD when being within range. The RF announcement signal BD_ANNOUNCE may, for instance, be a BLE advertising signal. As a result, the mobile device MD and the base device BD may communicate 510b, 510a to establish an RF connection, such as a BLE link. Corresponding functionality may be included also in the embodiments of FIG. 4A and FIG. 4B even though not being shown in these drawings.

As seen at 520a and 520b, the mobile device MD and the base device BD communicate so that the mobile device MD may determine a received signal strength RSS_MD. Correspondingly, the base device BD may determine a received signal strength RSS_BD. The latter is not mandatory but is nevertheless beneficially used in the disclosed embodiment, since it allows the base device BD to send 550 proximity indicative data P_DATA to the mobile device MD only when a variation has been detected 542 according to one or more readings from the detection output of the proximity sensor P.

In the embodiments shown in FIG. 5A-5E, the proximity indicative data P_DATA thus contains a proximity detection indicator P_DET similar to the one described above for FIG. 4B. As an alternative, the embodiments shown in FIG. 5A-FIG. 5E may be based on a representative value P_VALUE, as described above for FIG. 4A.

The mobile device MD is configured for evaluating the first proximity condition COND_R by checking 530 whether the received signal strength RSS_MD as determined in 520b meets a threshold value MD_THR. If the check in 530 is affirmative, see Yes, the execution proceeds to 560. Otherwise, see No, the execution returns to 520b for a renewed determination of the received signal strength RSS_MD at a certain periodicity or scheme.

As with FIGS. 4A and 4B, the received signal strength may, for instance, be determined from an RSSI (Received Signal Strength Indicator) included in the RF communication from the base device BD.

The mobile device MD is configured for evaluating the second proximity condition COND_P by detecting 560 the proximity detection indicator P_DET in the received proximity indicative data P_DATA. The second proximity condition COND_P is affirmed, see YES, when the proximity detection indicator P_DET is detected, and so the execution proceeds to 570 to trigger the digital action MD_BLIP. If the proximity detection indicator P_DET is not detected, the mobile device MD may be configured to keep on monitoring for it during a certain time period, the expiry of which may cause a timeout and return of the execution to 520b.

FIG. 5B illustrates an embodiment where the mobile device MD is configured to handle a situation in which a proximity detection indicator P_DET is received from the base device BD (see 532, 533, Yes), even though the received signal strength RSS_MD has not been determined as meeting the threshold MD_THR (see 530, No). This situation may occur if the proximity sensor P of the base device BD duly detects a variation in physical property caused by the mobile device MD being immediately close, but the threshold MD_THR is too high to notice the RF-based proximity of the mobile device MD to the base device BD.

Accordingly, the mobile device MD is configured for detecting 532, 533 that the second proximity condition COND_P has been affirmed without the first proximity condition COND_R being affirmed within a certain time period. In response, the mobile device MD is configured for sending 534 a report MD_THR_TOO_HIGH to a remote server resource RSR. The report may be sent over a broadband communication network BBCN. Such reports may be used by a service provider or device manufacturer to tune the threshold MD_THR for future instances of mobile devices, or even existing ones by including an adjusted threshold MD_THR′ in an upcoming update of the software application hosting the functionality performed by the mobile device MD in the present invention and its embodiments.

FIG. 5C illustrates an embodiment in which the mobile device MD is configured to handle an opposite situation where a proximity detection indicator P_DET is not received from the base device BD (see 560, 561, Timeout), even though the received signal strength RSS_MD has indeed been determined to meet the threshold MD_THR (see 530, Yes). This situation may occur if the threshold MD_THR is low enough to cause a premature reaction to the received signal strength RSS_MD in 530—i.e. when the mobile device MD is in fact not (yet) sufficiently close to the base device BD (e.g. farther than the distance D2 explained for FIG. 2B and FIG. 2C).

Accordingly, the mobile device MD is configured for detecting 560, 561 that the first proximity condition COND_R has been affirmed without the second proximity condition COND_P being affirmed within a certain time period, In response, the mobile device MD is configured for sending 562 a report MD_THR_TOO_LOW to a remote server resource RSR. The report may be sent over a broadband communication network BBCN. Such reports may be used by a service provider or device manufacturer to tune the threshold MD_THR similar to what has been described above for FIG. 5B.

FIG. 5D illustrates an embodiment where the base device BD is configured to handle a plurality of mobiles devices appearing proximate to the base device BD. Thus, in FIG. 5D, one or more additional mobile devices MD2 . . . MDn is/are provided. Each additional mobile device MD2 . . . MDn has a wireless RF transceiver and is configured for communicating 520b with the base device BD by RF communication to determine a respective received signal strength value.

The base device BD is configured for communicating 520a with each additional mobile device MD2 . . . MDn by RF communication to determine a respective received signal strength value for each additional mobile device MD2 . . . MDn. The base device BD is also configured for determining 541 satisfying device(s) among the mobile device MD and the additional mobile devices MD2 . . . MDn which has/have a received signal strength value meeting the threshold value BD_THR.

The base device BD is further configured, based on the determining 541, to send 551 the proximity indicative data P_DATA to the mobile device MD by RF communication to one or more MD, MD2 of the satisfying devices MD, MD2, . . . , MDn. For instance, the base device BD may be configured to send 551 the proximity indicative data P_DATA to the one single device MD among the satisfying device(s) MD, MD2 that has the highest received signal strength value. This may be beneficial in that it reduces the risk of the proximity indicative data P_DATA being sent to the wrong mobile device, for instance a customer being the second in line at a counter or cash register, where rightfully the first customer in line should receive the proximity indicative data P_DATA and trigger the digital action.

Alternatively, the base device BD may be configured to send 551 the proximity indicative data P_DATA to each satisfying device MD, MD2. This may be beneficial in use cases where it is desired to support triggering of parallel digital actions by more than one mobile device.

Still alternatively, the base device BD may be configured to send 551 the proximity indicative data P_DATA to the single one mobile device MD that was first detected by the base device BD, i.e. in accordance with a First Come First Serve (FCFS) policy.

FIG. 5E illustrates an embodiment in which the base device BD is configured to handle a situation where the base device BD does not detect a variation in physical property (see 542, 543, Timeout), even though the received signal strength RSS_BD as determined in 520a and assessed in 541 is high enough for at least one mobile device. The reason may be that the threshold BD_THR is too low and causes RF detection of mobile devices even though they are not close enough to the base device BD to be detected by the proximity sensor P.

Accordingly, the base device BD is configured for detecting 543 a timeout caused by the proximity sensor P not detecting 542 a variation in physical property, even though the base device BD has determined 541 at least one satisfying device among the mobile device MD and the additional mobile devices MD2 . . . MDn. The base device BD is configured to send 544, as a result, a report BD_THR_TOO_LOW to a remote server resource RSR. The information may be used for tuning the base device to adjust the threshold BD_THR to a higher value.

Any or all combination(s) of the embodiments of FIG. 5A to FIG. 5E is/are conceivable and intended in the present invention. Also, any or all of the embodiments of FIG. 5A to FIG. 5E may be combined with the embodiment of FIG. 4A or the embodiment of FIG. 4B, as is readily realized by a person skilled in the art.

The proximity-based digital action MD_BLIP being triggered in different embodiments of the present invention may, for instance, be a check-in action to register or verify the presence of the user U of the mobile device MD at the physical location PL. Alternatively, the proximity-based digital action MD_BLIP may, for instance, be an affirmative action, or a declining or cancelling action, in a digital transaction performed by the user U with the mobile device MD, or an action of associating the mobile device MD or its user U with a digital transaction which may be ongoing.

It is recalled that the present invention may advantageously be applied in or at physical locations in the form of, without limitation, a retail premise, an office premise, a residential premise, an industrial premise, an exhibition premise, and an outdoor scenery. The invention may, for instance, be used for triggering of digital actions for any of the purposes referred to in the background section of this document, without limitation.

The remote server resource RSR may, for instance, be a server computer, a cluster of such computer devices, or a cloud computing resource or service. It has a processing unit in the form of, for instance, one or more CPUs and/or DSPs, and is programmed to perform its functionality as described in this document by the processing unit executing program instructions of a computer program. The broadband communication network BBCN may, for instance, be a mobile communications network compliant with, for instance, WCDMA, HSPA, GSM, UTRAN, UMTS, LTE or LTE, and the broadband data communication may, for instance, be TCP/IP traffic, possibly encrypted or otherwise secured.

FIG. 6A illustrates a mobile computing device 150 which may implement the mobile device MD. The mobile computing device 150 comprises a user interface 151, typically comprising a presentation device and an input device (possibly combined). The mobile computing device 150 also comprises a memory 152. The memory 152 may store a software application 153a, SW hosting the functionality performed by the mobile device MD in the present invention and its embodiments. The memory 152 may further store the threshold value MD_THR.

The mobile computing device 150 also comprises a controller 154, a short-range wireless communication interface 156 (constituting or including the wireless RF transceiver MD_TX/RX), and a long-range broadband communication interface 158. The controller 154 may be configured for performing the functionality defined for the mobile device MD in the communication system 100 as described herein, for instance by executing program instructions of the software application 153a, SW.

The mobile computing device 150 may, for instance, be a mobile phone, tablet computer, personal digital assistant, smart glasses, smart watch or smart bracelet. The controller 154 may be a processing unit in the form of, for instance, one or more microcontrollers, CPUs and/or DSPs, being programmed to perform its functionality as described in this document by the processing unit executing program instructions of a computer program (e.g. software application 153a, SW). Alternatively, the controller 154 may be implemented as an FPGA, ASIC, etc.

FIG. 6B illustrates a base device 160 which may implement the base device BD. The base device 150 comprises a proximity sensor 161 in the form of the aforementioned proximity sensor P. The base device 150 also comprises a memory 162. The memory 162 may store a software program 163a, SW hosting the functionality performed by the base device BD in the present invention and its embodiments. The memory 162 may further store the threshold value BD_THR.

The base device 160 also comprises a controller 164, a short-range wireless communication interface 166 (constituting or including the wireless RF transceiver BD_TX/RX), and optionally a long-range broadband communication interface 168. The controller 164 may be configured for performing the functionality defined for the base device BD in the communication system 100 as described herein, for instance by executing program instructions of the software application 163a, SW. The controller 164 may be a processing unit in the form of, for instance, one or more microcontrollers, CPUs and/or DSPs. Alternatively, the controller 164 may, for instance, be implemented as an FPGA, ASIC, etc.

FIG. 6C illustrates the base device 160 in one embodiment 160-C. In this embodiment, the base device 160-C comprises a proximity sensor specifically in the form of a capacitive sensor 161-C. The other components of the base device 160-C may be the same as for the base device 160 according to FIG. 6B.

In this embodiment, the physical property monitored, measured or otherwise sensed by the proximity sensor/capacitive sensor 161-C is capacitance. In some implementations, the detector output from the capacitive sensor 161-C may take on values which may depend on the degree of proximity of the mobile device MD (or other object) from the capacitive sensor 161-C. For instance, a distance of 0.0 cm (i.e. actual contact with a sensor surface of the capacitive sensor 161-C) may yield a different detector output than a distance of, for instance, 0.2 cm (i.e. almost contact but not actually), which in turn may be different from the detector output in the idle situation when the mobile device MD (or other object) is not immediately close to the capacitive sensor 161-C at all (i.e. at some distance exceeding the capacitive detection range of the capacitive sensor 161-C, therefore not being detected). In other implementations, the detector output from the capacitive sensor 161-C may be a “binary” value, i.e. taking on a first value which represents the idle situation where no mobile device MD (or other object) is present, and a second value which represents detection of the mobile device MD (or other object) when being immediately close to the capacitive sensor 161-C, determined as the exceeding of some predetermined capacitive threshold value.

FIG. 6D illustrates the base device 160 in another embodiment 160-I. In this embodiment, the base device 160-I comprises a proximity sensor specifically in the form of an inductive sensor 161-I. The other components of the base device 160-I may be the same as for the base device 160 according to FIG. 6B.

In this embodiment, the physical property monitored, measured or otherwise sensed by the proximity sensor/inductive sensor 161-I is inductance. In some implementations, the detector output from the inductive sensor 161-I may take on values which may depend on the degree of proximity of the mobile device MD (or other object) from the inductive sensor 161-I. For instance, a distance of 0.1 cm may yield a different detector output than a distance of, for instance, 1.0 cm, which in turn may be different from the detector output in the idle situation when the mobile device MD (or other object) is not immediately close to the inductive sensor 161-I at all (i.e. at some distance exceeding the inductive detection range of the inductive sensor 161-I, therefore not being detected). In other implementations, the detector output from the inductive sensor 161-I may be a “binary” value, essentially as described above for the embodiment in FIG. 6C.

FIG. 6E illustrates the base device 160 in yet another embodiment 160-M. In this embodiment, the base device 160-M comprises a proximity sensor specifically in the form of a mechanical sensor 161-M. The other components of the base device 160-M may be the same as for the base device 160 according to FIG. 6B.

In this embodiment, the physical property monitored, measured or otherwise sensed by the proximity sensor/mechanical sensor 161-M is electrical resistance. In some implementations of this embodiment, the mechanical sensor 161-M may be a mechanical switch sensor, having a depressible member coupled for actuation of an electrical switch when being depressed by the user pressing (or tapping) with the mobile device MD against the depressible member. In such implementations, the detector output from the mechanical sensor 161-M will be a “binary” value, taking on a first value in the idle situation when the depressible member is not actuated, and a second value when actuated as a result of the mobile device MD being immediately close to the mechanical sensor 161-M.

In other implementations of this embodiment, the mechanical sensor 161-M may be a mechanical displacement sensor having a movable member, wherein the degree of displacement of the movable member will change the electrical resistance monitored, measured or otherwise sensed by the proximity sensor/mechanical sensor 161-M. This will allow the detector output from the mechanical sensor 161-M to take on values which will depend on the degree of displacement of the movable member, as actuated by the mobile device MD. For instance, a displacement of 0.2 cm may yield a different detector output than a displacement of, for instance, 0.5 cm, which in turn may be different from the detector output in the idle situation when the mobile device MD (or other object) is not immediately close to the mechanical sensor 161-M at all, and no displacement of the movable member therefore takes place.

An advantage of the embodiment in FIG. 6E is that the provision of a mechanical sensor 161-M with a depressible or movable member may give the user U a sensation of tactile feedback when actuating the depressible or movable member with the mobile device MD.

FIG. 6F illustrates the base device 160 in still another embodiment 160-L. In this embodiment, the base device 160-L comprises a proximity sensor specifically in the form of a light sensor 161-L for measuring incident light. The other components of the base device 160-M may be the same as for the base device 160 according to FIG. 6B.

In this embodiment, the physical property monitored, measured or otherwise sensed by the proximity sensor/light sensor 161-L is light intensity.

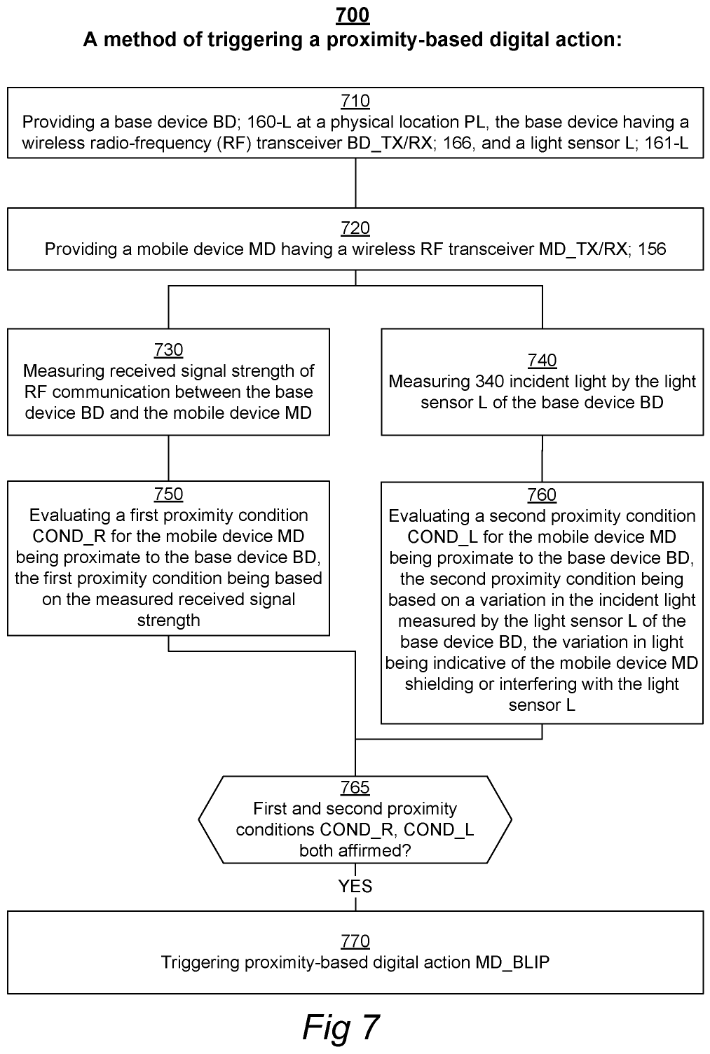

Reference is now made to FIG. 7. Generally corresponding to FIG. 3, FIG. 7 is a flowchart diagram of a general method 700 of triggering a proximity-based digital action for an embodiment where the proximity sensor P is a light sensor L, such as for instance the light sensor 161-L of the base device 160-L in the embodiment shown in FIG. 6F.

The method 700 involves the following.

As already mentioned and seen at 710 in FIG. 7, the base device BD is provided at a physical location PL. It is recalled that the base device BD has a wireless RF transceiver BD_TX/RX and, in this embodiment, a proximity sensor in the form of a light sensor L. The light sensor L may, for instance, comprise a photodetector or photosensor, such as a photodiode, photoresistor, phototransistor or photoconductor; an active-pixel sensor, such as a CMOS image sensor; a charge-coupled device (CCD); an infrared detector; or a photovoltaic cell.

As seen at 720 in FIG. 7, the method 700 also involves providing the mobile device MD. It is recalled that the mobile device has a wireless RF transceiver MD_TX/RX.

The method 700 further involves measuring, see 730, received signal strength of RF communication between the base device BD and the mobile device MD, as well as measuring, see 740, incident light by the light sensor L of the base device BD. Step 740 in FIG. 7 thus implements step 340 in FIG. 3 of obtaining a detection output of the proximity sensor of the base device BD.

The method 700 then involves evaluating, see 750, a first proximity condition COND_R for the mobile device MD being proximate to the base device BD. As has already been described with reference to the preceding drawings, the first proximity condition is based on the measured received RF signal strength.

The method 700 also involves evaluating, see 760, a second proximity condition COND_L for the mobile device MD being proximate to the base device BD. The second proximity condition is based on a variation in the incident light measured by the light sensor L of the base device BD. Hence, the variation in light is indicative of the mobile device MD shielding or interfering with the light sensor L when the user U brings the mobile device MD very close to the light sensor of the base device BD, such as within a 0-10 cm distance, for instance. Step 760 in FIG. 7 thus implements step 360 in FIG. 3, wherein the second proximity condition is now referred to as COND_L instead of COND_P.

The proximity-based digital action MD_BLIP is triggered, see 770, only when both of the first and second proximity conditions COND_R, COND_L have been affirmed, see 765, by the evaluations 750 and 760.

The sequence of steps 730 and 750 on the one hand, and the sequence of steps 740 and 760 on the other hand, may be performed in parallel or in any mutually sequential order.

The method in FIG. 7 has considerable advantages. It represents a substantial improvement in accuracy over distance estimation based purely on received signal strength, as described in the background section of this document. The provision and inventive use of the light sensor L (i.e. the second proximity condition COND_L) allow for an additional verification of the mobile device's MD close proximity to the base device BD, thereby considerably improving the positional accuracy of the method of triggering a proximity-based digital action. The light sensor L will only detect a variation in incident light when the mobile device MD (or another object) is immediately close to the light sensor L and base device BD. Moreover, the parallel use of the distance estimation based on received signal strength (i.e. the first proximity condition COND_R) will minimize the risk of inadvertent triggering of the digital action MD_BLIP caused by the light sensor L detecting an object not being the mobile device MD or the user U.

The method in FIG. 7 is advantageous also over alternative solutions (not to be confused with the present invention), where the mobile device rather than the base device would be provided with a non-RF-based mechanism for combined proximity verification. These advantageous aspects have already been explained in conjunction with the description of FIG. 3 above.

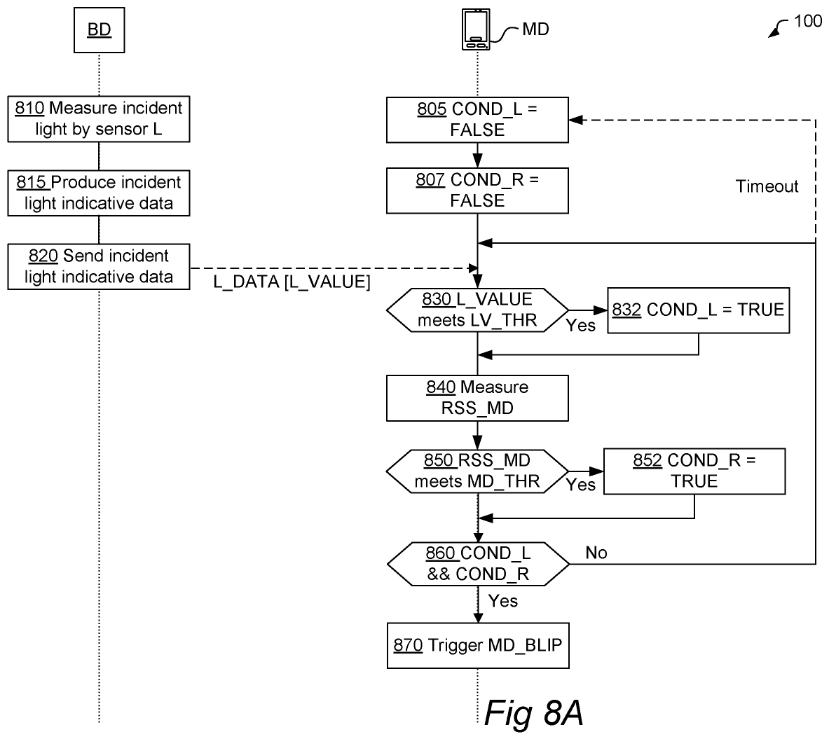

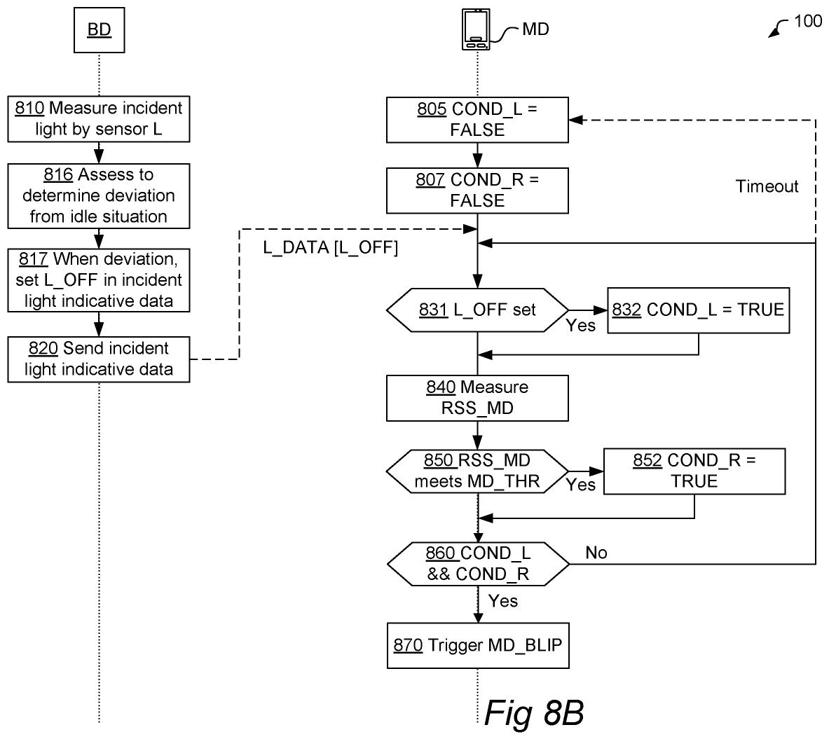

Embodiments of the method 700 and communication system 100 are shown in FIG. 8A and FIG. 8B, which generally correspond to FIG. 4A and FIG. 4B. As seen at 810, the light sensor L of the base device BD measures incident light, as previously described. The base device BD is configured for producing 815 (FIG. 8A); 816-817 (FIG. 8B) incident light indicative data L_DATA from one or more measurement readings by the light sensor L. The base device BD is configured for sending 820 the incident light indicative data L_DATA to the mobile device MD by RF communication. The incident light indicative data L_DATA may be broadcasted in an RF signal to be received by all devices within range, for instance in a Scan Response message. Alternatively, if an RF connection, such as a BLE link, has been established between the mobile device MD and the base device (cf 910a and 910b in FIG. 9A-FIG. 9E), the incident light indicative data L_DATA may be addressed individually to the mobile device MD.

The mobile device MD is configured for receiving the incident light indicative data L_DATA from the base device BD. The mobile device MD is further configured for evaluating the second proximity condition COND_L by determining 830 (FIG. 8A); 831 (FIG. 8B) whether the received incident light indicative data L_DATA satisfies predetermined criteria.

The mobile device MD is further configured for evaluating the first proximity condition COND_R by measuring 840 received signal strength of RF communication with the base device BD to establish a received signal strength value RSS_MD. The mobile device MD compares 850 the received signal strength value RSS_MD to a threshold value MD_THR, and affirms 852 the first proximity condition COND_R when the received signal strength value RSS_MD meets the threshold value MD_THR.

The received signal strength may, for instance, be determined from an RSSI (Received Signal Strength Indicator) included in RF communication from the base device BD. The RSSI may be expressed in dBm and have typical negative values ranging between 0 dBm (excellent signal) and, for instance, −110 dBm (extremely poor signal). Generally, the shorter distance between the base device BD and the mobile device MD, the higher RSSI.

The RF communication from the base device BD may, for instance, be the short-range wireless announcement signal BD_ANNOUNCE which was described for FIG. 2A, or RF communication resulting from the establishment of an RF connection between the base device BD and mobile device MD (cf FIG. 9A-FIG. 9E).

As seen at 860 and 870 in FIG. 8A and FIG. 8B, the mobile device MD is configured for checking whether both of the first and second proximity conditions COND_R, COND_L have been affirmed, as indicated by their logically true values set in steps 832 and 852 (initially, in steps 805 and 807, logically false values have been set for the first and second proximity conditions COND_R, COND_L).

The mobile device MD is further configured, when the outcome of the check in 860 is affirmative for both COND_R and COND_L, to trigger the digital action MD_BLIP in 870.

In the embodiment of FIG. 8A, the incident light indicative data L_DATA produced 815 by the base device BD comprises a value L_VALUE which is representative of incident light intensity. More specifically, the representative value L_VALUE may be an absolute value of incident light intensity, derived from one or more measurements readings from the light sensor L. The representative value L_VALUE may be an average of a sequence of measurements readings from the light sensor L.

Alternatively, the representative value L_VALUE may be a relative value of incident light intensity, defined in relation to a reference value which represents an idle situation where the light sensor L is not shielded or interfered with. Again, the representative value L_VALUE is derived from one or more measurements readings from the light sensor L, advantageously from an average of a sequence of measurements readings from the light sensor L.

The mobile device MD is configured to evaluate the second proximity condition COND_L by comparing 830 the representative value L_VALUE to a threshold value LV_THR, being an absolute threshold value or a relative threshold value as the case may be.

In a refined version of the embodiment of FIG. 8A, the base device BD is configured for repeatedly producing 815 the representative value L_VALUE and its representative value L_VALUE, and for repeatedly sending 820 the incident light indicative data L_DATA including the representative value L_VALUE to the mobile device MD. This may improve stability and reliability. The mobile device MD is configured for repeatedly receiving and evaluating 830 the incident light indicative data L_DATA. The second proximity condition COND_L is affirmed 832 when the representative value L_VALUE in the received incident light indicative data L_DATA meets the threshold value LV_THR for a certain period of time.

In the embodiment of FIG. 8B, the base device BD is configured for producing the incident light indicative data L_DATA by assessing 816 the one or more measurement readings from the light sensor L to determine a deviation from an idle situation in which the light sensor L is not shielded or interfered with. When the deviation from the idle situation has been determined, the base device BD is configured for providing 817 a light sensor block indicator L_OFF in or as the incident light indicative data L_DATA which is then sent 820 to the mobile device MD. The light sensor block indicator L_OFF may be included as a data field in the incident light indicative data L_DATA, or it may constitute the entire incident light indicative data L_DATA, depending on implementation.

The mobile device MD is configured for evaluating the second proximity condition COND_L by detecting 831 the light sensor block indicator L_OFF of the received incident light indicative data L_DATA. The second proximity condition COND_L is affirmed 832 when the light sensor block indicator L_OFF is detected.

In a refined version of the embodiment of FIG. 8B, for improved stability and reliability, the base device BD is configured for repeatedly assessing 816 the measurement readings from the light sensor L and providing 817 the light sensor block indicator L_OFF when the deviation from the idle situation has prevailed for a certain period of time.

Further embodiments are shown in FIG. 9A-9E. In FIG. 9A, the base device BD may send 900 an RF announcement signal BD_ANNOUNCE which may be received by the mobile device MD when being within range. The RF announcement signal BD_ANNOUNCE may, for instance, be a BLE advertising signal. As a result, the mobile device MD and the base device BD may communicate 910b, 910a to establish an RF connection, such as a BLE link. Corresponding functionality may be included also in the embodiments of FIG. 8A and FIG. 8B even though not being shown in these drawings.

As seen at 920a and 920b, the mobile device MD and the base device BD communicates such that the mobile device MD may determine a received signal strength RSS_MD. Correspondingly, the base device BD may determine a received signal strength RSS_BD. The latter is not mandatory but is nevertheless beneficially used in the disclosed embodiment, since it allows the base device BD to send 950 incident light indicative data L_DATA to the mobile device MD only when a light variation has been detected 942 according to one or more measurement reading from the light sensor L.

In the embodiments shown in FIG. 9A-9E, the incident light indicative data L_DATA thus contains a light sensor block indicator L_OFF similar to the one described above for FIGS. 8A and 8B. As an alternative, the embodiments shown in FIG. 9A-FIG. 9E may be based on a representative value L_VALUE, as described for FIG. 8A and FIG. 8B above.

The mobile device MD is configured for evaluating the first proximity condition COND_R by checking 930 whether the received signal strength RSS_MD as determined in 920b meets a threshold value MD_THR. If the check in 930 is affirmative, see Yes, the execution proceeds to 960. Otherwise, see No, the execution returns to 920b for a renewed determination of the received signal strength RSS_MD at a certain periodicity or scheme.

As with FIGS. 8A and 8B, the received signal strength may, for instance, be determined from an RSSI (Received Signal Strength Indicator) included in the RF communication from the base device BD.

The mobile device MD is configured for evaluating the second proximity condition COND_L by detecting 960 the light sensor block indicator L_OFF of the received incident light indicative data L_DATA. The second proximity condition COND_L is affirmed, see YES, when the light sensor block indicator L_OFF is detected and the execution proceeds to 970 to trigger the digital action MD_BLIP. If the light sensor block indicator L_OFF is not detected, the mobile device MD may be configured to keep on monitoring for it during a certain time period, the expiry of which may cause a timeout and return of the execution to 920b.

FIG. 9B illustrates an embodiment where the mobile device MD is configured to handle a situation in which a light sensor block indicator L_OFF is received from the base device BD (see 932, 933, Yes), even though the received signal strength RSS_MD has not been determined as meeting the threshold MD_THR (see 930, No). This situation may occur if the light sensor L of the base device BD duly detects a variation in incident light caused by the mobile device MD being in close proximity, but the threshold MD_THR is too high to notice the RF-based proximity of the mobile device MD to the base device BD.

Accordingly, the mobile device MD is configured for detecting 932, 933 that the second proximity condition COND_L has been affirmed without the first proximity condition COND_R being affirmed within a certain time period. In response, the mobile device MD is configured for sending 934 a report MD_THR_TOO_HIGH to a remote server resource RSR. The report may be sent over a broadband communication network BBCN. Such reports may be used by a service provider or device manufacturer to tune the threshold MD_THR for future instances of mobile devices, or even existing ones by including an adjusted threshold MD_THR′ in an upcoming update of the software application hosting the functionality performed by the mobile device MD in the present invention and its embodiments.

FIG. 9C illustrates an embodiment in which the mobile device MD is configured to handle an opposite situation where a light sensor block indicator L_OFF is not received from the base device BD (see 960, 961, Timeout), even though the received signal strength RSS_MD has indeed been determined to meet the threshold MD_THR (see 930, Yes). This situation may occur if the threshold MD_THR is low enough to cause a premature reaction to the received signal strength RSS_MD in 930—i.e. when the mobile device MD is in fact not (yet) sufficiently close to the base device BD (e.g. farther than the distance D2 explained for FIG. 2B and FIG. 2C).

Accordingly, the mobile device MD is configured for detecting 960, 961 that the first proximity condition COND_R has been affirmed without the second proximity condition COND_L being affirmed within a certain time period, In response, the mobile device MD is configured for sending 962 a report MD_THR_TOO_LOW to a remote server resource RSR. The report may be sent over a broadband communication network BBCN. Such reports may be used by a service provider or device manufacturer to tune the threshold MD_THR similar to what has been described above for FIG. 9B.

FIG. 9D illustrates an embodiment where the base device BD is configured to handle a plurality of mobiles devices appearing proximate to the base device BD. Thus, in FIG. 9D, one or more additional mobile devices MD2 . . . MDn is/are provided. Each additional mobile device MD2 . . . MDn has a wireless RF transceiver and is configured for communicating 920b with the base device BD by RF communication to determine a respective received signal strength value.

The base device BD is configured for communicating 920a with each additional mobile device MD2 . . . MDn by RF communication to determine a respective received signal strength value for each additional mobile device MD2 . . . MDn. The base device BD is also configured for determining 941 satisfying device(s) among the mobile device MD and the additional mobile devices MD2 . . . MDn which has/have a received signal strength value meeting the threshold value BD_THR.

The base device BD is further configured, based on the determining 941, to send 951 the incident light indicative data L_DATA to the mobile device MD by RF communication to one or more MD, MD2 of the satisfying devices MD, MD2, . . . , MDn. For instance, the base device BD may be configured to send 951 the incident light indicative data L_DATA to the one single device MD among the satisfying device(s) MD, MD2 that has the highest received signal strength value. This may be beneficial in that it reduces the risk of the incident light indicative data L_DATA being sent to the wrong mobile device, for instance a customer being the second in line at a counter or cash register, where rightfully the first customer in line should receive the incident light indicative data L_DATA and trigger the digital action.

Alternatively, the base device BD may be configured to send 951 the incident light indicative data L_DATA to each satisfying device MD, MD2. This may be beneficial in use cases where it is desired to support triggering of parallel digital actions by more than one mobile device.

Still alternatively, the base device BD may be configured to send 951 the incident light indicative data L_DATA to the single one mobile device MD that was first detected by the base device BD, i.e. in accordance with a First Come First Serve (FCFS) policy.

FIG. 9E illustrates an embodiment in which the base device BD is configured to handle a situation where the base device BD does not detect a light variation (see 942, 943, Timeout), even though the received signal strength RSS_BD as determined in 920a and assessed in 941 is high enough for at least one mobile device. The reason may be that the threshold BD_THR is too low and causes detection of mobile devices even though they are not close enough to the base device BD to be detected by the light sensor L.

Accordingly, the base device BD is configured for detecting 943 a timeout caused by the light sensor L not detecting 942 a variation in light, even though the base device BD has determined 941 at least one satisfying device among the mobile device MD and the additional mobile devices MD2 . . . MDn. The base device BD is configured to send 944, as a result, a report BD_THR_TOO_LOW to a remote server resource RSR. The information may be used for tuning the base device to adjust the threshold BD_THR to a higher value.

Any or all combination(s) of the embodiments of FIG. 9A to FIG. 9E is/are conceivable and intended in the present invention. Also, any or all of the embodiments of FIG. 9A to FIG. 9E may be combined with the embodiment of FIG. 8A or the embodiment of FIG. 8B, as is readily realized by a person skilled in the art.

Even though Bluetooth Low Energy, BLE, is presently considered an advantageous short-range wireless communication technology for the wireless RF transceivers BD_TX/RX and MD_TX/RX, other technologies are also conceivable, including but not limited to near-field communication (NFC), radio frequency identification (RFID), wireless LAN (WLAN, WiFi), or another form of proximity-based device-to-device radio communication signal such as LTE Direct.

For embodiments which are indeed based on BLE, the following summary of BLE and beacon technology based on BLE is believed to facilitate the understanding of some embodiments of the present invention.

The iBeacon technology from Apple allows for mobile devices to understand their location on a micro-local scale, and also allows delivery of hyper-contextual content to the users of mobile devices based on their current location. The iBeacon technology is based on the BLE standard, and more particularly on Generic Access Profile (GAP) advertising packets. There are several other kinds of short-range wireless beacon technologies, for instance AltBeacon, URIBeacon and Eddystone, which are also based on BLE and GAP.

In a basic short-range wireless beacon communication system based on the BLE standard, a beacon transmitter device repeatedly broadcasts a short-range wireless beacon advertisement signal in a 31-byte GAP BLE packet. The beacon advertisement signal contains a 128-bit universally unique identifier, UUID. The beacon advertisement signal may also include a 16-bit major portion and a 16-bit minor portion. The beacon signal identifies a beacon region associated with the beacon transmitter device. Whereas, as is commonly known, a geographical region is an area defined by a circle of a specified radius around a known point on the Earth's surface, a beacon region is in contrast an area defined by a mobile device's proximity to one or more beacon transmitter devices.

In some implementations, the beacon region is represented by the UUID, the major portion and the minor portion in the beacon advertisement signal. In other implementations, the beacon region is represented by the UUID and the major or minor portion in the beacon signal. In still other implementations, the beacon region is represented by the UUID alone.

To be able to receive the short-range wireless beacon signal when being within range of a beacon transmitter device, each mobile device is provided with an application program, app, which is configured to detect and react on short-range wireless beacon signals, such as the aforementioned beacon advertisement signal, with support from the underlying operating system. In one known beacon technology, the apps in mobile devices can detect and react on beacons in two ways, monitoring and ranging. Monitoring enables the app to detect movement in and out of the beacon region (i.e., whether the mobile device is within or outside of the range of any of the beacon transmitter devices with which the beacon region is associated). Hence, monitoring allows the app to scan for beacon regions. Ranging is more granular and provides a list of beacon transmitter devices in range, together with their respective received signal strength, which may be used to estimate a distance to each of them. Hence, ranging allows the app to detect and react on individual beacon transmitter devices in a beacon region.

These apps may be handled by the operating system of the mobile device in different modes. The most prominent mode is the active mode, in which the app executes in the foreground and is typically capable of interacting with the user of the mobile device and also to communicate with an external device such as a server via the short-range wireless beacon interface and/or another communication interface. As regards short-range wireless beacon communication, ranging typically only works when the app is in active mode.

When a mobile device receives the beacon advertisement signal, the app in the mobile device may detect that it has entered the beacon region from the UUID (and the major/minor as the case may be) contained in the beacon advertisement signal, and react as appropriate in some way which is beneficial to the user and/or the host of the beacon transmitter device and which often involves interaction between the app in the mobile device and a service provider over a broadband communication network. A system server may also be included in some implementations.

Examples of such beneficial use include, without limitation, determining a current approximate position of the mobile device by retrieving a predefined position of the beacon transmitter device from the service provider or by cross reference with local lookup data, or retrieving content from the service provider.

A mobile device where the app is in active mode is referred to as an active mobile device in this document. An active mobile device may receive and react to additional transmissions of the beacon advertisement signal from the beacon transmitter device; this may be useful for instance if the content associated with the host of the beacon transmitter device is updated or changed.

Furthermore, an active mobile device may receive and react to beacon advertisement signals from other beacon transmitter devices nearby, provided of course that they are within range of the respective beacon transmitter device, or move closer to it. This is so irrespective of whether the different beacon transmitter devices advertise the same beacon region (i.e. contain the same UUID and major/minor in the respective beacon advertisement signals), or different beacon regions (provided that the app is configured to monitor for such different beacon regions). It is to be noticed that the same beacon region (e.g. same UUID) is very often used for different beacon transmitter devices hosted by the same host, such as within the same supermarket, arena, fastfood restaurant, etc.

The operating system of the mobile devices may also handle apps in a passive mode. A purpose of the passive mode is power preservation, since the mobile devices are typically powered by batteries and since it is a general technical ambition to maximize the operational time of a mobile device between successive charging sessions. In the passive mode, the app executes in the background or is only installed on the mobile device. Monitoring works when the app is in active mode as well as when the app is in passive mode, whereas ranging may only work when the app is in active mode, or may only work for a limited time period when the app is in passive mode.

Transitions between active mode and passive mode may be based on user interaction, user preference settings in the app or the operating system, or program logic in the app or the operating system.

A mobile device where the app is in passive mode is referred to as a passive mobile device in this document. In the passive mode, the app typically cannot interact with the user via the user interface, nor communicate with a server or another device—except for the following. Just like active mobile devices, a nearby passive mobile device may monitor for a beacon region and hence receive a short-range wireless beacon advertisement signal if it is within range of the beacon transmitter device in question. However, unlike active mobile devices, the passive mobile device will not be able to use ranging functionality to estimate a distance to the beacon transmitter device.

The invention has mainly been described above with reference to a few embodiments. However, as is readily appreciated by a person skilled in the art, other embodiments than the ones disclosed above are equally possible within the scope of the invention, as defined by the appended patent claims.

Alternative inventive aspects are defined in the following numbered clauses.

I. A method (300) of triggering a proximity-based digital action, comprising:

providing (310) a base device (BD) at a physical location (PL), the base device having a wireless radio-frequency, RF, transceiver (BD_TX/RX; 166) and a light sensor (L);

providing (320) a mobile device (MD), the mobile device having a wireless RF transceiver (MD_TX/RX; 156);

measuring (330) received signal strength of RF communication between the base device (BD) and the mobile device (MD);

measuring (340) incident light by the light sensor (L) of the base device (BD);

evaluating (350) a first proximity condition (COND_R) for the mobile device (MD) being proximate to the base device (BD), the first proximity condition being based on the measured received signal strength; and evaluating (360) a second proximity condition (COND_L) for the mobile device (MD) being proximate to the base device (BD), the second proximity condition being based on a variation in the incident light measured by the light sensor (L) of the base device (BD), the variation in light being indicative of the mobile device (MD) shielding or interfering with the light sensor (L); and

triggering (370) the proximity-based digital action (MD_BLIP) when both of the first and second proximity conditions (COND_R, COND_L) have been affirmed (365) by the evaluations (350, 360).

II. The method as defined in clause I, further comprising:

the base device (BD) producing (415; 416-417) incident light indicative data (L_DATA) from one or more measurement readings by the light sensor (L) of the base device (BD);

the base device (BD) sending (420) the incident light indicative data (L_DATA) to the mobile device (MD) by RF communication;

the mobile device (MD) receiving the incident light indicative data (L_DATA); and

the mobile device (MD) evaluating (360) the second proximity condition (COND_L) by determining (430; 431) whether the received incident light indicative data (L_DATA) satisfies predetermined criteria.

III. The method as defined in clause II,

wherein the incident light indicative data (L_DATA) produced (415) by the base device (BD) comprises a value (L_VALUE) representative of incident light intensity, the representative value (L_VALUE) being one of:
an absolute value of incident light intensity; and
a relative value of incident light intensity, defined in relation to a reference value representing an idle situation where the light sensor (L) is not shielded or interfered with; and

wherein the mobile device (MD) evaluates (360) the second proximity condition (COND_L) by comparing (430) said representative value (L_VALUE) to a threshold value (LV_THR).

IV. The method as defined in clause III, wherein:

the base device (BD) repeatedly produces (415) said representative value (L_VALUE) and sends (420) the incident light indicative data (L_DATA) including said representative value (L_VALUE) to the mobile device (MD); and

the mobile device (MD) repeatedly receives and evaluates (360; 430) the incident light indicative data (L_DATA), the second proximity condition (COND_L) being affirmative (432) when said representative value (L_VALUE) in the received incident light indicative data (L_DATA) meets said threshold value (LV_THR) for a certain period of time.

V. The method as defined in clause II,

wherein the base device (BD) produces (416-417) the incident light indicative data (L_DATA) by:

assessing (416) said one or more measurement readings from the light sensor (L) to determine a deviation from an idle situation where the light sensor (L) is not shielded or interfered with; and

when the deviation from the idle situation has been determined, providing (417) a light sensor block indicator (L_OFF) as or in the incident light indicative data (L_DATA) for sending (420) to the mobile device (MD); and

wherein the mobile device (MD) evaluates (360) the second proximity condition (COND_L) by:

detecting (431) the light sensor block indicator (L_OFF) of the received incident light indicative data (L_DATA), the second proximity condition (COND_L) being affirmative (432) when the light sensor block indicator (L_OFF) is detected.

VI. The method as defined in clause V, wherein:

the base device (BD) repeatedly assesses (416) the measurement readings from the light sensor (L) and provides (417) the light sensor block indicator (L_OFF) when the deviation from the idle situation has prevailed for a certain period of time.

VII. The method as defined in any of clauses II-VI, wherein the mobile device (MD) evaluates (360) the first proximity condition (COND_R) by:

measuring (330; 440) received signal strength of RF communication with the base device (BD) to establish a received signal strength value (RSS_MD);

comparing (450) the received signal strength value (RSS_MD) to a threshold value (MD_THR); and

affirming (452) the first proximity condition (COND_R) when the received signal strength value (RSS_MD) meets the threshold value (MD_THR).

VIII. The method as defined in any preceding clause, further comprising:

detecting (532, 533) that the second proximity condition (COND_L) has been affirmed without the first proximity condition (COND_R) being affirmed within a certain time period; and

sending (534) a report (MD_THR_TOO_HIGH) to a remote server resource (RSR).

IX. The method as defined in any of clauses I-VII, further comprising:

detecting (560, 561) that the first proximity condition (COND_R) has been affirmed without the second proximity condition (COND_L) being affirmed within a certain time period; and

sending (562) a report (MD_THR_TOO_LOW) to a remote server resource (RSR).

X. The method as defined in any of clauses II-IX, further comprising:

providing one or more additional mobile devices (MD2 . . . MDn), each additional mobile device having a wireless RF transceiver;

each additional mobile device (MD2 . . . MDn) communicating (520b) with the base device (BD) by RF communication to determine a respective received signal strength value;

the base device (BD) communicating (520a) with each additional mobile device (MD2 . . . MDn) by RF communication to determine a respective received signal strength value for each additional mobile device (MD2 . . . MDn);

the base device (BD) determining (541) satisfying device(s) among the mobile device (MD) and the additional mobile devices (MD2 . . . MDn) which has/have a received signal strength value exceeding the threshold value (BD_THR); and

based on the determining (541), the base device (BD) sending (551) the incident light indicative data (L_DATA) to the mobile device (MD) by RF communication to one or more (MD, MD2) of the satisfying devices (MD, MD2, . . . , MDn).

XI. The method as defined in clause X, wherein the base device (BD) sends (551) the incident light indicative data (L_DATA) to the one single device (MD) among the satisfying device(s) (MD, MD2) that has the highest received signal strength value.

XII. The method as defined in clause X, wherein the base device (BD) sends (551) the incident light indicative data (L_DATA) to each satisfying device (MD, MD2).

XIII. The method as defined in any of clauses X-XII, further comprising the base device (BD):

detecting (543) a timeout caused by the light sensor (L) not detecting (542) a variation in light even though the base device (BD) has determined (541) at least one satisfying device among the mobile device (MD) and the additional mobile devices (MD2 . . . MDn); and

sending (544) a report (BD_THR_TOO_LOW) to a remote server resource (RSR).

XIV. The method as defined in any preceding clause, wherein the physical location (PL) is in or at one of:

a retail premise,

an office premise,

a residential premise,

an industrial premise,

an exhibition premise, and

an outdoor scenery.

XV. The method as defined in any preceding clause, wherein the proximity-based digital action (MD_BLIP) is one of:

a check-in action to register or verify the presence of a user (U) of the mobile device (MD) at the physical location (PL);

an affirmative action in a digital transaction performed by the user (U) with the mobile device (MD);

a declining action in a digital transaction performed by the user (U) with the mobile device (MD);

a cancelling action in a digital transaction performed by the user (U) with the mobile device (MD); and

an action of associating the mobile device (MD) or its user (U) with a digital transaction.

XVI. A mobile computing device (150; MD) comprising:

a controller (154); and

a short-range wireless communication interface (156; MD_TX/RX),

wherein the mobile computing device (MD) is configured for:

measuring (330; 440) received signal strength of RF communication with a base device (BD) to establish a received signal strength value (RSS_MD);

evaluating (350), based on the measured received signal strength (RSS_MD), a first proximity condition (COND_R) for the mobile device (MD) being proximate to the base device (BD;

receiving incident light indicative data (L_DATA) from the base device (BD); and

evaluating (360), based on the received incident light indicative data (L_DATA), a second proximity condition (COND_L) for the mobile device (MD) being proximate to the base device (BD), the second proximity condition being based on a variation in incident light measured by a light sensor (L) of the base device (BD) and indicative of the mobile device (MD) shielding or interfering with the light sensor (L); and

triggering (370: 470) a proximity-based digital action (MD_BLIP) when both of the first and second proximity conditions (COND_R, COND_L) have been affirmed (365; 460).

XVII. The mobile computing device (MD; 150) as defined in clause 16, configured for performing the functionality defined for the mobile device (MD) in the method according to any of clauses I-XV.

XVIII. A base device (160; BD) comprising:

a controller (164);

a short-range wireless communication interface (166; BD_TX/RX); and

a light sensor (L),

wherein the base device (BD) is configured for:

communicating (500; 510a-b) with a mobile device (MD) by RF communication;

producing (415; 416-417) incident light indicative data (L_DATA) from one or more measurement readings by the light sensor (L); and

sending (420) the incident light indicative data (L_DATA) to the mobile device (MD) by RF communication.

XIX. The base device (160; BD) as defined in clause XVIII, configured for performing the functionality defined for the base device (BD) in the method according to any of clauses I-XV.

XX. A communication system (100) comprising:

one or more mobile computing devices (150; MD) as defined in clause XVI or XVII; and

a base device (160; BD) as defined in clause XVIII or XIX.

XXI. A method (300) of triggering a proximity-based digital action, comprising:

providing (310) a base device (BD) at a physical location (PL), the base device having a wireless radio-frequency, RF, transceiver (BD_TX/RX; 166) and a proximity sensor (P);

providing (320) a mobile device (MD), the mobile device having a wireless RF transceiver (MD_TX/RX; 156);

measuring (330) received signal strength of RF communication between the base device (BD) and the mobile device (MD);

obtaining (340) a detection output of the proximity sensor (P) of the base device (BD);

evaluating (350) a first proximity condition (COND_R) for the mobile device (MD) being proximate to the base device (BD), the first proximity condition being based on the measured received signal strength; and

evaluating (360) a second proximity condition (COND_P) for the mobile device (MD) being proximate to the base device (BD), the second proximity condition being based on a variation in detection output of the proximity sensor (P) of the base device (BD), the variation in the detection output being indicative of the mobile device (MD) appearing immediately close to the proximity sensor (P); and

triggering (370) the proximity-based digital action (MD_BLIP) when both of the first and second proximity conditions (COND_R, COND_P) have been affirmed (365) by the evaluations (350, 360).

1. A method of triggering a proximity-based digital action, comprising:
providing a base device at a physical location, the base device having a short-range wireless radio-frequency, RF, transceiver and a proximity sensor;
providing a mobile device, the mobile device having a short-range wireless RF transceiver;
the mobile device measuring received signal strength of RF communication between the base device and the mobile device;
the base device obtaining detection output of the proximity sensor of the base device;
the base device producing proximity indicative data from the detection output of the proximity sensor;
the base device sending the proximity indicative data to the mobile device by RF communication;
the mobile device receiving the proximity indicative data;
the mobile device evaluating a first proximity condition for the mobile device being proximate to the base device, the first proximity condition being based on the measured received signal strength; and
the mobile device evaluating a second proximity condition for the mobile device being proximate to the base device by determining whether the proximity indicative data satisfies predetermined criteria, the second proximity condition being based on a variation in detection output of the proximity sensor of the base device, the variation in the detection output being indicative of the mobile device appearing immediately close to the proximity sensor; and
the mobile device triggering the proximity-based digital action when both of the first and second proximity conditions have been affirmed by the evaluations.

2. The method as defined in claim 1,
wherein the proximity indicative data produced by the base device comprises a value representative a physical property detected by the proximity sensor, the representative value being one of:
an absolute value of the physical property; and
a relative value of the physical property, defined in relation to a reference value representing an idle situation in which the mobile device is not immediately close to the proximity sensor; and
wherein the mobile device evaluates the second proximity condition by comparing said representative value to a threshold value.

3. The method as defined in claim 2, wherein:
the base device repeatedly produces said representative value and sends the proximity indicative data including said representative value to the mobile device; and
the mobile device repeatedly receives and evaluates the proximity indicative data, the second proximity condition being affirmative when said representative value in the received proximity indicative data meets said threshold value for a certain period of time.

4. The method as defined in claim 1,
wherein the base device produces the proximity indicative data by:
assessing the detection output from the proximity sensor to determine a deviation from an idle situation in which the mobile device is not immediately close to the proximity sensor; and
when the deviation from the idle situation has been determined, providing a proximity detection indicator as or in the proximity indicative data for sending to the mobile device; and
wherein the mobile device evaluates the second proximity condition by:
detecting the proximity detection indicator of the received proximity indicative data, the second proximity condition being affirmative when the proximity detection indicator is detected.

5. The method as defined in claim 4, wherein:
the base device repeatedly assesses the detection output from the proximity sensor and provides the proximity detection indicator when the deviation from the idle situation has prevailed for a certain period of time.

6. The method as defined in claim 1, wherein the mobile device evaluates the first proximity condition by:
measuring received signal strength of RF communication with the base device to establish a received signal strength value;
comparing the received signal strength value to a threshold value; and
affirming the first proximity condition when the received signal strength value meets the threshold value.

7. The method as defined in claim 1, further comprising:
detecting that the second proximity condition has been affirmed without the first proximity condition being affirmed within a certain time period; and
sending a report to a remote server resource.

8. The method as defined in claim 1, further comprising:
detecting that the first proximity condition has been affirmed without the second proximity condition being affirmed within a certain time period; and
sending a report to a remote server resource.

9. The method as defined in claim 1, further comprising:
providing one or more additional mobile devices, each additional mobile device having a wireless RF transceiver;
each additional mobile device communicating with the base device by RF communication to determine a respective received signal strength value;
the base device communicating with each additional mobile device by RF communication to determine a respective received signal strength value for each additional mobile device;
the base device determining satisfying device(s) among the mobile device and the additional mobile devices which has/have a received signal strength value exceeding the threshold value; and
based on the determining, the base device sending the proximity indicative data to the mobile device by RF communication to one or more of the satisfying devices.

10. The method as defined in claim 9, wherein the base device sends the proximity indicative data to the one single device among the satisfying device(s) that has the highest received signal strength value.

11. The method as defined in claim 9, wherein the base device sends the proximity indicative data to each satisfying device.

12. The method as defined in claim 9, further comprising the base device:
detecting a timeout caused by the proximity sensor not detecting a variation in the detection output of the proximity sensor even though the base device has determined at least one satisfying device among the mobile device and the additional mobile devices; and
sending a report to a remote server resource.

13. The method as defined in claim 1, wherein the proximity sensor of the base device is selected from the group consisting of:
a capacitive sensor;
a Doppler effect sensor;
an eddy current sensor;
an inductive sensor;
a magnetic sensor;
an infrared sensor;
an optical photoelectric sensor;
a photocell sensor;
a laser rangefinder sensor;
a thermal sensor;
a radar sensor;
a sonar sensor;
an ultrasonic sensor;
a Hall effect sensor;
a piezoelectric sensor;
a mechanical switch sensor; and
a mechanical displacement sensor.

14. The method as defined in claim 1, wherein the proximity sensor of the base device is a light sensor for measuring incident light.

15. The method as defined in claim 14, wherein the second proximity condition is based on a variation in the incident light measured by the light sensor of the base device, the variation in light being indicative of the mobile device shielding or interfering with the light sensor.

16. The method as defined in claim 15, wherein the proximity indicative data produced by the base device from the detection output of the proximity sensor is incident light indicative data produced by the base device from one or more measurement readings by the light sensor.

17. The method as defined in claim 1, wherein the physical location is in or at one of:
a retail premise,
an office premise,
a residential premise,
an industrial premise,
an exhibition premise, and
an outdoor scenery.

18. The method as defined in claim 1, wherein the proximity-based digital action is one of:
a check-in action to register or verify the presence of a user of the mobile device at the physical location;
an affirmative action in a digital transaction performed by the user with the mobile device;
a declining action in a digital transaction performed by the user with the mobile device;
a cancelling action in a digital transaction performed by the user with the mobile device; and
an action of associating the mobile device or its user with a digital transaction.

19. A mobile device comprising:
a controller; and
a short-range wireless communication interface,
wherein the mobile device is configured for:
measuring received signal strength of radio-frequency, RF, communication with a base device to establish a received signal strength value;
evaluating, based on the measured received signal strength, a first proximity condition for the mobile device being proximate to the base device;
receiving proximity indicative data from the base device;
evaluating, based on the proximity indicative data, a second proximity condition for the mobile device being proximate to the base device, the second proximity condition being based on a variation in detection output of a proximity sensor of the base device, the variation in the detection output being indicative of the mobile device appearing immediately close to the proximity sensor; and
triggering a proximity-based digital action when both of the first and second proximity conditions have been affirmed.

20. The mobile device as defined in claim 19, wherein the proximity sensor of the base device is a light sensor for measuring incident light, and wherein the second proximity condition is based on a variation in the incident light measured by the light sensor of the base device, the variation in light being indicative of the mobile device shielding or interfering with the light sensor.

21. (canceled)

22. A base device comprising:
a controller;
a short-range wireless communication interface; and
a proximity sensor,
wherein the base device is configured for:
communicating with a mobile device by radio-frequency, RF, communication;
producing proximity indicative data from detection output of the proximity sensor; and
sending the proximity indicative data to the mobile device by RF communication.

23. The base device as defined in claim 22, wherein the base device is configured for producing the proximity indicative data from the detection output of the proximity sensor, such that the proximity indicative data will enable the mobile device to evaluate whether the mobile device is being proximate to the base device based on a variation in the detection output of the proximity sensor, the variation in the detection output thus being indicative of the mobile device appearing immediately close to the proximity sensor.

24. The base device as defined in claim 22, wherein the proximity sensor is selected from the group consisting of:
a capacitive sensor;
a Doppler effect sensor;
an eddy current sensor;
an inductive sensor;
a magnetic sensor;
an infrared sensor;
an optical photoelectric sensor;
a photocell sensor;
a laser rangefinder sensor;
a thermal sensor;
a radar sensor;
a sonar sensor;
an ultrasonic sensor;
a Hall effect sensor;
a piezoelectric sensor;
a mechanical switch sensor; and
a mechanical displacement sensor.

25. The base device as defined in claim 22, wherein the proximity sensor is a light sensor for measuring incident light.

26. The base device as defined in claim 25, wherein the proximity indicative data produced from the detection output of the proximity sensor is incident light indicative data produced from one or more measurement readings by the light sensor.

27. (canceled)

28. A communication system comprising:
one or more mobile devices as defined in claim 19; and
a base device comprising:
a controller;
a short-range wireless communication interface; and
a proximity sensor,
wherein the base device is configured for:
communicating with a mobile device by radio-frequency, RF, communication;
producing proximity indicative data from detection output of the proximity sensor; and
sending the proximity indicative data to the mobile device by RF communication.

29. The mobile device as defined in claim 19, wherein the proximity indicative data comprises a value representative a physical property detected by the proximity sensor of the base device, the representative value being one of:
an absolute value of the physical property; and
a relative value of the physical property, defined in relation to a reference value representing an idle situation in which the mobile device is not immediately close to the proximity sensor; and
wherein the mobile device is configured for evaluating the second proximity condition by comparing said representative value to a threshold value.

30. The mobile device as defined in claim 29, wherein the mobile device is configured for repeatedly receiving and evaluating the proximity indicative data, the second proximity condition being affirmative when said representative value in the received proximity indicative data meets said threshold value for a certain period of time.

31. The mobile device as defined in claim 19, further being configured for evaluating the first proximity condition by:
comparing the received signal strength value to a threshold value; and
affirming the first proximity condition when the received signal strength value meets the threshold value.

32. The mobile device as defined in claim 19, further being configured for:
detecting that one of the first and second proximity conditions has been affirmed without the other of the first and second proximity conditions having being affirmed within a certain time period; and
sending a report to a remote server resource.

33. The base device as defined in claim 22,
wherein the proximity indicative data produced by the base device comprises a value representative a physical property detected by the proximity sensor, the representative value being one of:
an absolute value of the physical property; and
a relative value of the physical property, defined in relation to a reference value representing an idle situation in which the mobile device is not immediately close to the proximity sensor.

34. The base device as defined in claim 22, further being configured for producing the proximity indicative data by:
assessing the detection output from the proximity sensor to determine a deviation from an idle situation in which the mobile device is not immediately close to the proximity sensor; and
when the deviation from the idle situation has been determined, providing a proximity detection indicator as or in the proximity indicative data for sending to the mobile device.

35. The base device as defined in claim 34, further being configured for:
repeatedly assessing the detection output from the proximity sensor; and
providing the proximity detection indicator when the deviation from the idle situation has prevailed for a certain period of time.
